(19) United States
(12) Patent Application Publication
(10) Pub. No.: US 2016/0184996 A1
(43) Pub. Date: Jun. 30, 2016

(54) ROBOT, ROBOT SYSTEM, CONTROL APPARATUS, AND CONTROL METHOD

(71) Applicant: Seiko Epson Corporation, Tokyo (JP)

(72) Inventors: Taro ISHIGE, Matsumoto (JP); Tomokazu HIRABAYASHI, Hara (JP); Ikuma FURIHATA, Matsumoto (JP)

(21) Appl. No.: 14/978,379

(22) Filed: Dec. 22, 2015

(30) Foreign Application Priority Data
Dec. 24, 2014 (JP) 2014-259934
Dec. 25, 2014 (JP) 2014-261868
Dec. 25, 2014 (JP) 2014-261869

(51) Int. Cl. B25J 9/16; B25J 9/00

(52) U.S. Cl. CPC B25J 9/1692; B25J 9/1694; B25J 9/0084; Y10S 901/09

(57) ABSTRACT

In order to provide a robot which easily calibrates a manipulator, a robot includes an arm and a force sensor, in which the arm is calibrated by causing the arm to take a plurality of attitudes on the basis of an output value from at least the force sensor in a state in which a part of a first member attached to a tip of the arm is moved so that a distance between the part and a second member becomes a distance of 1 for each of a plurality of second members, the part being provided at a position which is not present on a rotation axis of the tip of the arm.

### BACKGROUND

1. Technical Field

The present invention relates to a robot, a robot system, a control apparatus, and a control method.

2. Related Art

In order to cause a robot to perform highly accurate work, research and development on calibration of a mechanism or an imaging apparatus of the robot, a work environment, or the like have been performed.

In relation thereto, there is a method in which tool center points (TCPs) of a manipulators are mechanically constrained with certain tools without using an external measurement device, or the manipulators are coupled to each other, and thus calibration of the manipulators is performed (for example, refer to JP-A-2013-184236, and http://www.cs.utah.edu/-jmh/Papers/Hollerbach_IJRR96.pdf “The Calibration Index And Taxonomy for Robot Kinematics Calibration Methods (John M. Hollerbach, et al.): Closed Loop Kinematic Calibration”).

A position of the TCP which is moved due to driving of the manipulator can be calculated on the basis of the forward kinematics by giving a rotation angle of each of a plurality of actuators of the manipulator. An actual position of the TCP reaching when the actuator is driven in order to realize the given rotation angle may be different from a calculated position of the TCP due to influences of errors caused by elasticity of members constituting the manipulator. In the present specification, calibration of the manipulator indicates that a rotation angle of each actuator is corrected so that a difference between an actual position of the TCP and a calculated position of the TCP is reduced.

There is a technique in which a plurality of robots are positioned in order to perform cooperative work among a plurality of manipulators (for example, refer to JP-A-5-111897).

For example, in a relative positional relationship acquisition method disclosed in JP-A-5-111897, a facial tool is attached to a tip of an arm of a first robot, and a needle tool is attached to a tip of an arm of a second robot. In this method, a tip of the needle tool is brought into point contact with a face of the facial tool at least at three points which are not present in the same straight line. In the method, a position of the tip of the needle tool during point contact is calculated in a base coordinate system of the first robot and a base coordinate system of the second robot. In the method, a coordinate transform matrix between the base coordinate system of the first robot and the base coordinate system of the second robot is calculated on the basis of the calculated position of the tip of the facial tool in the base coordinate system of the first robot and the calculated position of the tip of the needle tool in the base coordinate system of the second robot, and a relative positional relationship between the first robot and the second robot is obtained by using the calculated coordinate transform matrix.

However, in the method disclosed in JP-A-2013-184236, and http://www.cs.utah.edu/-jmh/Papers/Hollerbach_IJRR96.pdf “The Calibration Index And Taxonomy for Robot Kinematics Calibration Methods (John M. Hollerbach, et al.): Closed Loop Kinematic Calibration”, in a case where the manipulator is manually calibrated, since an operation of each actuator is stopped, and an attitude of the manipulator is required to be manually changed, time and effort are necessary. In a case where the manipulator is calibrated by driving each actuator, since calibration of the manipulator is not completed, the manipulator cannot be accurately moved, and it is hard to control the manipulator without applying a load to the actuator, a member, or the like constituting the manipulator in a state in which the TCPs are constrained. A large-scale jig which can resist an operation load of the manipulator is necessary in order to mechanically constrain the manipulator with a certain jig, and thus there is a problem in that an installation location or portability of the calibration jig is damaged.

In the robots disclosed in JP-A-5-111897, if both of the first robot and the second robot are not appropriately calibrated, work using both of the first robot and the second robot cannot be accurately performed.

### SUMMARY

An advantage of some aspects of the invention is to solve at least a part of the problems described above, and the invention can be implemented as the following forms or application examples.

An aspect of the invention is directed to a robot including an arm; and a force sensor, in which the arm is calibrated by causing the arm to take a plurality of attitudes on the basis of an output value from at least the force sensor in a state in which a part of a first member attached to a tip of the arm is moved so that a distance between the part and a second member becomes a distance of 1 for each of a plurality of second members, the part being provided at a position which is not present on a rotation axis of the tip of the arm.

With this configuration, the robot calibrates the arm by causing the arm to take a plurality of attitudes on the basis of an output value from at least the force sensor in a state in which a part of a first member attached to a tip of the arm is moved so that a distance between the part and a second member becomes a distance of 1 for each of a plurality of second members, the part being provided at a position which is not present on a rotation axis of the tip of the arm. Consequently, the robot can easily calibrate a manipulator.

As another aspect of the invention may employ a configuration in which, in the robot, the distance of 1 is substantially 0.

With this configuration, the robot calibrates the arm by causing the arm to take a plurality of attitudes on the basis of an output value from at least the force sensor in a state in which a part of a first member attached to a tip of the arm is moved so that a distance between the part and a second member becomes a distance of substantially 0 for each of a plurality of second members, the part being provided at a position which is not present on a rotation axis of the tip of the arm. Consequently, the robot can calibrate the arm by causing the arm to take one or more attitudes while maintaining a state in which the part of the first member is in contact with the second member.

Another aspect of the invention may employ a configuration in which, for each of the plurality of second members, the robot moves the part of the first member so that a distance between the part and the second member becomes the distance of 1, then moves the part so that a distance between the part and the second member becomes a distance which is different from the distance of 1 so as to initialize the force sensor, and then moves the part of the first member so that a distance between the part and the second member becomes the distance of 1.

With this configuration, for each of the plurality of second members, the robot moves the part of the first member so that a distance between the part and the second member becomes the distance of 1, then moves the part so that a distance between the part and the second member becomes a distance which is different from the distance of 1 so as to initialize the force sensor, and then moves the part of the first member so that a distance between the part and the second member becomes the distance of 1. Consequently, the robot can minimize errors caused by gravity applied to the force sensor.

Another aspect of the invention may employ a configuration in which, when the force sensor is initialized, the robot initializes the force sensor after waiting for vibration of the first member to be reduced, and moves the part of the first member so that a distance between the part and the second member becomes the distance of 1.

With this configuration, when the force sensor is initialized, the robot initializes the force sensor after waiting for vibration of the first member to be reduced, and moves the part of the first member so that a distance between the part and the second member becomes the distance of 1. Consequently, the robot can minimize errors in the initialization of the force sensor, caused by vibration of the first member.

Another aspect of the invention may employ a configuration in which the robot causes the arm to take a plurality of attitudes in a state in which the part of the first member is in contact with a depression of the second member.

With this configuration, the robot causes the arm to take a plurality of attitudes in a state in which the part of the first member is in contact with the depression of the second member. Consequently, the robot can calibrate the arm by causing the arm to take a plurality of attitudes in a state in which a position of the part of the first member is fixed.

Another aspect of the invention may employ a configuration in which the robot includes two or more arms, and the robot collectively calibrates the two or more arms.

With this configuration, the robot collectively calibrates the two or more arms. Consequently, the robot can improve accuracy of cooperative work between two or more arms.

An aspect of the invention is directed a robot system including a robot including an arm and a force sensor; a control apparatus that operates the robot; a first member that includes an end portion at a position which is not present on a rotation axis of a tip of the arm; and a plurality of second members, in which the control apparatus calibrates the arm by causing the arm to take a plurality of attitudes on the basis of an output value from at least the force sensor in a state in which a part of the first member attached to the tip of the arm is moved so that a distance between the part and the second member becomes a distance of 1 for each of the plurality of second members, the part being provided at a position which is not present on the rotation axis of the tip of the arm.

With this configuration, the robot system calibrates the arm by causing the arm to take a plurality of attitudes on the basis of an output value from at least the force sensor in a state in which a part of a first member attached to a tip of the arm is moved so that a distance between the part and a second member becomes a distance of 1 for each of a plurality of second members, the part being provided at a position which is not present on a rotation axis of the tip of the arm. Consequently, the robot system can easily calibrate a manipulator.

An aspect of the invention is directed to a control apparatus which calibrates an arm of a robot by causing the arm to take a plurality of attitudes on the basis of an output value from at least a force sensor in a state in which a part of a first member attached to a tip of the arm is moved so that a distance between the part and a second member becomes a distance of 1 for each of a plurality of second members, the part being provided at a position which is not present on a rotation axis of the tip of the arm.

With this configuration, the control apparatus calibrates the arm of the robot by causing the arm to take a plurality of attitudes on the basis of an output value from at least the force sensor in a state in which a part of a first member attached to a tip of the arm is moved so that a distance between the part and a second member becomes a distance of 1 for each of a plurality of second members, the part being provided at a position which is not present on a rotation axis of the tip of the arm. Consequently, the control apparatus can easily calibrate a manipulator.

An aspect of the invention is directed to a control method including calibrating an arm of a robot by causing the arm to take a plurality of attitudes on the basis of an output value from at least a force sensor in a state in which a part of a first member attached to a tip of the arm is moved so that a distance between the part and a second member becomes a distance of 1 for each of a plurality of second members, the part being provided at a position which is not present on a rotation axis of the tip of the arm.

With this configuration, in the control method, the arm of the robot is calibrated by causing the arm to take a plurality of attitudes on the basis of an output value from at least the force sensor in a state in which a part of a first member attached to a tip of the arm is moved so that a distance between the part and a second member becomes a distance of 1 for each of a plurality of second members, the part being provided at a position which is not present on a rotation axis of the tip of the arm. Consequently, in the control method, a manipulator can be easily calibrated.

As described above, in the robot, the robot system, the control apparatus, and the control method, the arm is calibrated by causing the arm to take a plurality of attitudes on the basis of an output value from at least the force sensor in a state in which the part of the first member attached to the tip of the arm is moved so that a distance between the part and the second member becomes the distance of 1 for each of a plurality of second members, the part being provided at a position which is not present on a rotation axis of the tip of the arm. Consequently, in the robot, the robot system, the control apparatus, and the control method, a manipulator can be easily calibrated.

An aspect of the invention is directed to a robot including a main body; an arm; and a force sensor, in which the arm is calibrated by causing the arm to take a plurality of attitudes on the basis of an output value from at least the force sensor after a part of a first member attached to a tip of the arm is moved so that a distance between the part and a second member becomes a distance of 1, the part being provided at a position which is not present on a rotation axis of the tip of the arm.

With this configuration, the robot calibrates the arm by causing the arm to take a plurality of attitudes on the basis of an output value from at least the force sensor after a part of a first member attached to a tip of the arm is moved so that a distance between the part and a second member becomes a distance of 1, the part being provided at a position which is not present on a rotation axis of the tip of the arm. Consequently, the robot can easily calibrate a manipulator.

Another aspect of the invention may employ a configuration in which, in the robot, the distance of 1 is substantially 0.

With this configuration, the robot calibrates the arm by causing the arm to take a plurality of attitudes on the basis of an output value from at least the force sensor after a part of a first member attached to a tip of the arm is moved so that a distance between the part and a second member becomes a distance of substantially 0, the part being provided at a position which is not present on a rotation axis of the tip of the arm. Consequently, the robot can calibrate the arm by causing the arm to take one or more attitudes while maintaining a state in which the part of the first member is in contact with the second member.

Another aspect of the invention may employ a configuration in which the robot moves the part of the first member so that a distance between the part and the second member becomes the distance of 1, then moves the part so that a distance between the part and the second member becomes a distance which is different from the distance of 1 so as to initialize the force sensor, and then moves the part of the first member so that a distance between the part and the second member becomes the distance of 1.

With this configuration, the robot moves the part of the first member so that a distance between the part and the second member becomes the distance of 1, then moves the part so that a distance between the part and the second member becomes a distance which is different from the distance of 1 so as to initialize the force sensor, and then moves the part of the first member so that a distance between the part and the second member becomes the distance of 1. Consequently, the robot can minimize errors caused by gravity applied to the force sensor.

Another aspect of the invention may employ a configuration in which, when the force sensor is initialized, the robot initializes the force sensor after waiting for vibration of the first member to be reduced, and moves the part of the first member so that a distance between the part and the second member becomes the distance of 1.

With this configuration, when the force sensor is initialized, the robot initializes the force sensor after waiting for vibration of the first member to be reduced, and moves the part of the first member so that a distance between the part and the second member becomes the distance of 1. Consequently, the robot can minimize errors in the initialization of the force sensor, caused by vibration of the first member.

Another aspect of the invention may employ a configuration in which the robot causes the arm to take a plurality of attitudes in a state in which the part of the first member is in contact with a depression of the second member.

With this configuration, the robot causes the arm to take a plurality of attitudes in a state in which the part of the first member is in contact with the depression of the second member. Consequently, the robot can calibrate the arm by causing the arm to take a plurality of attitudes in a state in which a position of the part of the first member is fixed.

Another aspect of the invention may employ a configuration in which the robot includes two or more arms, and the robot collectively calibrates the two or more arms.

With this configuration, the robot collectively calibrates the two or more arms. Consequently, the robot can improve accuracy of cooperative work between two or more arms.

An aspect of the invention is directed to a robot system including a robot including a main body, an arm, and a force sensor; a control apparatus that operates the robot; a first member that is attached on a tip side of the arm; and a second member, in which the control apparatus calibrates the arm by causing the arm to take a plurality of attitudes on the basis of an output value from at least the force sensor after a part of the first member is moved so that a distance between the part and the second member becomes a distance of 1, the part being provided at a position which is not present on the rotation axis of the tip of the arm.

With this configuration, the robot system calibrates the arm by causing the arm to take a plurality of attitudes on the basis of an output value from at least the force sensor after a part of a first member attached to a tip of the arm is moved so that a distance between the part and a second member becomes a distance of 1, the part being provided at a position which is not present on a rotation axis of the tip of the arm. Consequently, the robot system can easily calibrate a manipulator.

An aspect of the invention is directed to a control apparatus which calibrates an arm of a robot by causing the arm to take a plurality of attitudes on the basis of an output value from at least a force sensor after a part of a first member attached to a tip of the arm is moved so that a distance between the part and a second member becomes a distance of 1, the part being provided at a position which is not present on a rotation axis of the tip of the arm.

With this configuration, the control apparatus calibrates the arm of the robot by causing the arm to take a plurality of attitudes on the basis of an output value from at least the force sensor after a part of a first member attached to a tip of the arm is moved so that a distance between the part and a second member becomes a distance of 1, the part being provided at a position which is not present on a rotation axis of the tip of the arm. Consequently, the control apparatus can easily calibrate a manipulator.

An aspect of the invention is directed to a control method including calibrating an arm of a robot by causing the arm to take a plurality of attitudes on the basis of an output value from at least a force sensor after a part of a first member attached to a tip of the arm is moved so that a distance between the part and a second member becomes a distance of 1, the part being provided at a position which is not present on a rotation axis of the tip of the arm.

With this configuration, in the control method, the arm of the robot is calibrated by causing the arm to take a plurality of attitudes on the basis of an output value from at least the force sensor after a part of a first member attached to a tip of the arm is moved so that a distance between the part and a second member becomes a distance of 1, the part being provided at a position which is not present on a rotation axis of the tip of the arm. Consequently, in the control method, a manipulator can be easily calibrated.

As described above, in the robot, the robot system, the control apparatus, and the control method, the arm is calibrated by causing the arm to take a plurality of attitudes on the basis of an output value from at least the force sensor after the part of the first member attached to the tip of the arm is moved so that a distance between the part and the second member becomes the distance of 1, the part being provided at a position which is not present on a rotation axis of the tip of the arm. Consequently, in the robot, the robot system, the control apparatus, and the control method, a manipulator can be easily calibrated.

An aspect of the invention is directed to a robot including a first arm; a second arm; a first member for the first arm that is attached on a tip side of the first arm; and a first member for the second arm that is attached on a tip side of the second arm, in which the robot performs a first operation of moving a part of the first member for the first arm so that a distance between the part and a second member becomes a distance of 1 and then causing the first arm to take a plurality of attitudes, and a second operation of moving a part of the first member for the second arm so that a distance between the part and the second member becomes a distance of 2 and then causing the second arm to take a plurality of attitudes, on the basis of a control signal acquired from a control apparatus, and calibrates a parameter for controlling the first arm and a parameter for controlling the second arm on the basis of results of the first operation and the second operation.

With this configuration, the robot performs a first operation of moving a part of the first member for the first arm so that a distance between the part and a second member becomes a distance of 1 and then causing the first arm to take a plurality of attitudes, and a second operation of moving a part of the first member for the second arm so that a distance between the part and the second member becomes a distance of 2 and then causing the second arm to take a plurality of attitudes, and calibrates a parameter for controlling the first arm and a parameter for controlling the second arm on the basis of results of the first operation and the second operation. Consequently, the robot can minimize errors when work is performed by using a plurality of arms.

Another aspect of the invention may employ a configuration in which, in the robot, the distance of 1 is substantially the same as a distance of 2.

With this configuration, the robot performs a first operation of moving the part of the first member for the first arm so that a distance between the part and the second member becomes the distance of 1 and then causing the first arm to take a plurality of attitudes, and a second operation of moving the part of the first member for the second arm so that a distance between the part and the second member becomes a distance of 2 which is substantially the same as the distance of 1 and then causing the second arm to take a plurality of attitudes, and calibrates the first arm and the second arm on the basis of results of the first operation and the second operation. Consequently, the robot can calibrate the first arm and the second arm by causing the first arm to take one or more attitude while maintaining a predetermined distance between the part of the first member for the first arm and the second member, and by causing the second arm to take one or more attitude while maintaining a predetermined distance between the part of the first member for the second arm and the second member.

Another aspect of the invention may employ a configuration in which, in the robot, both of the distance of 1 and the distance of 3 re substantially 0.

With this configuration, the robot performs a first operation of moving the part of the first member for the first arm so that a distance between the part and the second member becomes substantially 0 and then causing the first arm to take a plurality of attitudes, and a second operation of moving the part of the first member for the second arm so that a distance between the part and the second member becomes substantially 0 and then causing the second arm to take a plurality of attitudes, and calibrates the first arm and the second arm on the basis of results of the first operation and the second operation. Consequently, the robot can calibrate the first arm and the second arm by causing the first arm to take one or more attitude while maintaining a state in which the part of the first member for the first arm is in contact with the second member, and by causing the second arm to take one or more attitude while maintaining a state in which the part of the first member for the second arm is in contact with the second member.

Another aspect of the invention may employ a configuration in which the robot further includes a first force sensor and a second force sensor, the robot performs a first operation of moving the part of the first member for the first arm so that a distance between the part and the second member becomes the distance of 1, and then causing the first arm to take a plurality of attitudes on the basis of an output value from at least the first force sensor, and a second operation of moving the part of the first member for the second arm so that a distance between the part and the second member becomes the distance of 2, and then causing the second arm to take a plurality of attitudes on the basis of an output value from the second force sensor.

With this configuration, the robot performs a first operation of moving the part of the first member for the first arm so that a distance between the part and the second member becomes the distance of 1, and then causing the first arm to take a plurality of attitudes on the basis of an output value from at least the first force sensor, and a second operation of moving the part of the first member for the second arm so that a distance between the part and the second member becomes the distance of 2, and then causing the second arm to take a plurality of attitudes on the basis of an output value from the second force sensor. Consequently, the robot can calibrate the first arm and the second arm on the basis of results of the first operation and the second operation based on the output values from the force sensors.

Another aspect of the invention may employ a configuration in which, in a case of moving the part of the first member for the first arm so that a distance between the part and the second member becomes the distance of 1, the robot moves the part of the first member for the first arm so that a distance between the part and the second member becomes the distance of 1, then moves the part of the first member for the first arm so that a distance between the part and the second member becomes a distance which is different from the distance of 1 so as to initialize the first force sensor, and then moves the part of the first member for the first arm so that a distance between the part and the second member becomes the distance of 1; and in a case of moving the part of the first member for the second arm so that a distance between the part and the second member becomes the distance of 2, the robot moves the part of the first member for the second arm so that a distance between the part and the second member becomes the distance of 2, then moves the part of the first member for the second arm so that a distance between the part and the second member becomes a distance which is different from the distance of 2 in order to initialize the second force sensor, and then moves the part of the first member for the second arm so that a distance between the part and the second member becomes the distance of 2.

With this configuration, in a case of moving the part of the first member for the first arm so that a distance between the part and the second member becomes the distance of 1, the robot moves the part of the first member for the first arm so that a distance between the part and the second member becomes the distance of 1, then moves the part of the first member for the first arm so that a distance between the part and the second member becomes a distance which is different from the distance of 1 in order to initialize the first force sensor, and then moves the part of the first member for the first arm so that a distance between the part and the second member becomes the distance of 1; and in a case of moving the part of the first member for the second arm so that a distance between the part and the second member becomes the distance of 2, the robot moves the part of the first member for the second arm so that a distance between the part and the second member becomes the distance of 2, then moves the part of the first member for the second arm so that a distance between the part and the second member becomes a distance which is different from the distance of 2 in order to initialize the second force sensor, and then moves the part of the first member for the second arm so that a distance between the part and the second member becomes the distance of 2. Consequently, the robot can minimize errors caused by an external force such as gravity applied to the first and second force sensors.

Another aspect of the invention may employ a configuration in which, in a case of initializing the first force sensor, the robot waits for vibration of the first member for the first arm to be reduced, then initializes the first force sensor, and then moves the part of the first member for the first arm so that a distance between the part and the second member becomes the distance of 1; and in a case of initializing the second force sensor, the robot waits for vibration of the first member for the second arm to be reduced, then initializes the second force sensor, and then moves the part of the first member for the second arm so that a distance between the part and the second member becomes the distance of 2.

With this configuration, in a case of initializing the first force sensor, the robot waits for vibration of the first member for the first arm to be reduced, then initializes the first force sensor, and then moves the part of the first member for the first arm so that a distance between the part and the second member becomes the distance of 1; and in a case of initializing the second force sensor, the robot waits for vibration of the first member for the second arm to be reduced, then initializes the second force sensor, and then moves the part of the first member for the second arm so that a distance between the part and the second member becomes the distance of 2. Consequently, the robot can minimize errors in the initialization of the first force sensor, caused by vibration of the first member for the first arm, and errors in the initialization of the second force sensor, caused by vibration of the first member for the second arm.

Another aspect of the invention may employ a configuration in which, in the robot, the part of the first member for the first arm is provided at a position which is not present on a rotation axis of the tip of the first arm, and the part of the first member for the second arm is provided at a position which is not present on a rotation axis of the tip of the second arm.

With this configuration, the robot performs a first operation of causing the first arm to take a plurality of attitudes in a state in which the part of the first member for the first arm, provided at a position which is not present on a rotation axis of the tip of the first arm, is moved so that a distance between the part and a second member becomes the distance of 1, and a second operation of causing the second arm to take a plurality of attitudes in a state in which the part of the first member for the second arm, provided at a position which is not present on a rotation axis of the tip of the second arm, is moved so that a distance between the part and the second member becomes a distance of 2. Consequently, the robot can calibrate the rotation axis of the tip of the first arm and the rotation axis of the tip of the second arm on the basis of the first operation and the second operation.

Another aspect of the invention may employ a configuration in which the robot performs a first operation of causing the first arm to take a plurality of attitudes in a state in which the part of the first member for the first arm is in contact with a depression of the second member, and a second operation of causing the second arm to take a plurality of attitudes in a state in which the part of the first member for the second arm is in contact with the depression of the second member.

With this configuration, the robot performs a first operation of causing the first arm to take a plurality of attitudes in a state in which the part of the first member for the first arm is in contact with a depression of the second member, and a second operation of causing the second arm to take a plurality of attitudes in a state in which the part of the first member for the second arm is in contact with the depression of the second member. Consequently, the robot can fix a position of the part of the first member for the first arm and a position of the part of the first member for the second arm to the same position, and, as a result, can minimize errors caused by a position of the contact point between either or both of the part of the first member for the first arm and the part of the first member for the second arm and the second member being deviated.

Another aspect of the invention may employ a configuration in which, in the robot, the control apparatus collectively calibrates the first arm and the second arm on the basis of the results of the first operation and the second operation.

With this configuration, the robot collectively calibrates the first arm and the second arm on the basis of the results of the first operation and the second operation. Consequently, the robot can minimize errors related to calibration of the first arm and calibration of the second arm.

An aspect of the invention is directed to a robot calibration system including a robot provided with a first arm and a second arm; a control apparatus that operates the robot; a first member for the first arm attached on a tip side of the first arm; a first member for the second arm attached on a tip side of the second arm; and a second member, in which the control apparatus performs a first operation of moving a part of the first member for the first arm so that a distance between the part and a second member becomes a distance of 1 and then causing the first arm to take a plurality of attitudes, and a second operation of moving a part of the first member for the second arm so that a distance between the part and the second member becomes a distance of 2 and then causing the second arm to take a plurality of attitudes, and calibrates the first arm and the second arm on the basis of results of the first operation and the second operation.

With this configuration, the robot calibration system performs a first operation of moving a part of the first member for the first arm so that a distance between the part and a second member becomes a distance of 1 and then causing the first arm to take a plurality of attitudes, and a second operation of moving a part of the first member for the second arm so that a distance between the part and the second member becomes a distance of 2 and then causing the second arm to take a plurality of attitudes, and calibrates the first arm and the second arm on the basis of results of the first operation and the second operation. Consequently, the robot calibration system can minimize errors when work is performed by using a plurality of arms.

As described above, the robot and the robot calibration system perform a first operation of moving a part of the first member for the first arm so that a distance between the part and a second member becomes a distance of 1 and then causing the first arm to take a plurality of attitudes, and a second operation of moving a part of the first member for the second arm so that a distance between the part and the second member becomes a distance of 2 and then causing the second arm to take a plurality of attitudes, and calibrate a parameter for controlling the first arm and a parameter for controlling the second arm on the basis of results of the first operation and the second operation. Consequently, the robot and the robot calibration system can minimize errors when work is performed by using a plurality of arms.

### BRIEF DESCRIPTION OF THE DRAWINGS

The invention will be described with reference to the accompanying drawings, wherein like numbers reference like elements.

FIG. 1 is a configuration diagram illustrating an example of a robot system according to the present embodiment.

FIG. 2 is a diagram illustrating an example of a jig.

FIG. 3 is a diagram illustrating an example of a situation in which an attitude of a TCP is changed without a position of the TCP being changed in a case where a calibration information acquisition operation.

FIG. 4 is a diagram exemplifying respective joints of a first manipulator and a second manipulator provided in a robot, and a waist pivot of the robot.

FIG. 5 is a diagram illustrating an example of a first end effector.

FIG. 6 is a diagram illustrating an example a hardware configuration of a control apparatus.

FIG. 7 is a diagram illustrating an example of a functional configuration of the control apparatus.

FIG. 8 is a flowchart illustrating an example of a flow of processes until the control apparatus completes calibration of the first manipulator and the second manipulator.

FIGS. 9A to 9C are diagrams exemplifying attitudes of the first manipulator.

FIG. 10 is a configuration diagram illustrating an example of a robot system according to the present embodiment.

FIG. 11 is a flowchart illustrating an example of a flow of processes until the control apparatus completes calibration of the first manipulator and the second manipulator.

FIG. 12 is a configuration diagram illustrating an example of a robot system according to the present embodiment.

FIG. 13 is a diagram illustrating an example of a functional configuration of the control apparatus.

FIG. 14 is a flowchart illustrating an example of a flow of processes in which the control apparatus causes the robot to perform predetermined work.

### DESCRIPTION OF EXEMPLARY EMBODIMENTS

### First Embodiment

Hereinafter, a first embodiment of the invention will be described with reference to the drawings.

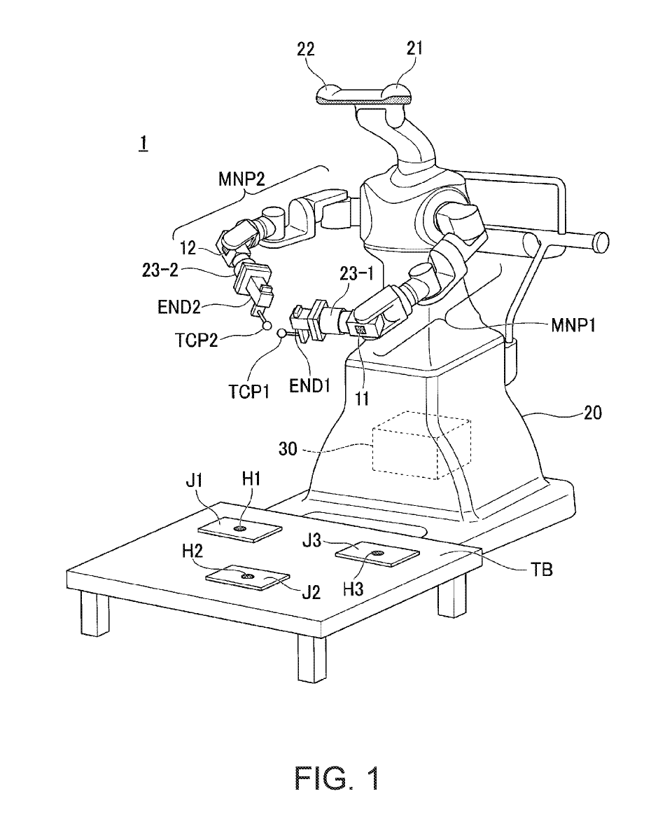

FIG. 1 is a configuration diagram illustrating an example of a robot system 1 according to the present embodiment.

The robot system 1 includes a robot 20 and a control apparatus 30. The robot system 1 calibrates manipulators included in the robot 20 by using a plurality of jigs. In this example, the robot system 1 is configured to use three jigs J1 to J3 illustrated in FIG. 1 as the plurality of jigs, but may be configured to use four or more jigs. Hereinafter, in a case where the jigs J1 to J3 are not required to be differentiated from each other, the jigs will be collectively referred to as jigs J.

Here, a description will be made of calibration of the manipulator performed by the robot system 1. The robot system 1 acquires information indicating a rotation angle of each of a plurality of actuators provided in the manipulator of the robot 20, from an encoder connected to (or included in) each actuator. The rotation angle of the actuator is an example of a parameter for controlling an arm. Hereinafter, for convenience of description, the rotation angle of the actuator will be simply referred to as a rotation angle in some cases.

In the robot system 1, the control apparatus 30 calculates a current position of a TCP of the manipulator by using the rotation angle acquired from each encoder on the basis of the forward kinematics. Hereinafter, for convenience of description, a position of the TCP of the manipulator will be simply referred to as a position of the TCP. The robot system 1 controls the robot 20 to perform various pieces of work by using the manipulator on the basis of the calculated position of the TCP.

However, the calculated position of the TCP may indicate a position which is different from an actual position of the TCP due to errors caused by elasticity of a member constituting the manipulator or errors related to rotation of the actuator. For example, assuming a case where the manipulator is provided with a single actuator, when a rotation angle acquired from the encoder is set to θ, and a rotation angle of the actuator for reproducing a calculated position of the TCP as an actual position of the TCP is set to θ, correction thereof is performed by adding a certain value η (either a positive value or a negative value) to the rotation angle θ as shown in the following Equation (1).

φ=θ+η (1)

Hereinafter, the value η for correcting a rotation angle of the actuator as shown in Equation (1) will be referred to as a joint offset. Therefore, the calibration of the manipulator performed by the robot system 1 indicates that a joint offset is calculated for each rotation angle of a plurality of actuators of the manipulator, and each rotation angle of the plurality of actuators of the manipulator is corrected by using the calculated joint offset. Hereinafter, for convenience of description, a joint offset for each rotation angle of the plurality of actuators of the manipulator will be simply referred to as a joint offset.

Through the calibration of the manipulator, the robot system 1 can cause a position of the TCP calculated on the basis of the forward kinematics to match an actual position of the TCP with high accuracy. As a result, the robot system 1 can cause the manipulator of the robot 20 to perform highly accurate work. Hereinafter, in the calibration of the manipulator, a description will be made of a process in which the robot system 1 calculates a joint offset for correcting a rotation angle of the actuator and teaches (stores) the calculated joint offset to (in) the control apparatus 30.

The three jigs J are provided on an upper surface of a work table TB. The respective three jigs J are disposed at any positions which do not overlap each other on the upper surface of the work table TB. The work table TB is a stand such as a table, but, alternatively, may be other objects such as a floor surface or a wall surface on which the respectively three jigs J can be installed. In this example, each of the three jigs J is a plate-like metal. The jig J1 has a depression H1 on its upper surface; the jig J2 has a depression H2 on its upper surface; and the jig J3 has a depression H3 on its upper surface. Hereinafter, in a case where the depressions H1 to H3 are not required to be differentiated from each other, the depressions will be collectively referred to as depressions H.

Each of the three jigs J may be other objects such as a floor surface or a wall surface as long as the depression H is provided thereon.

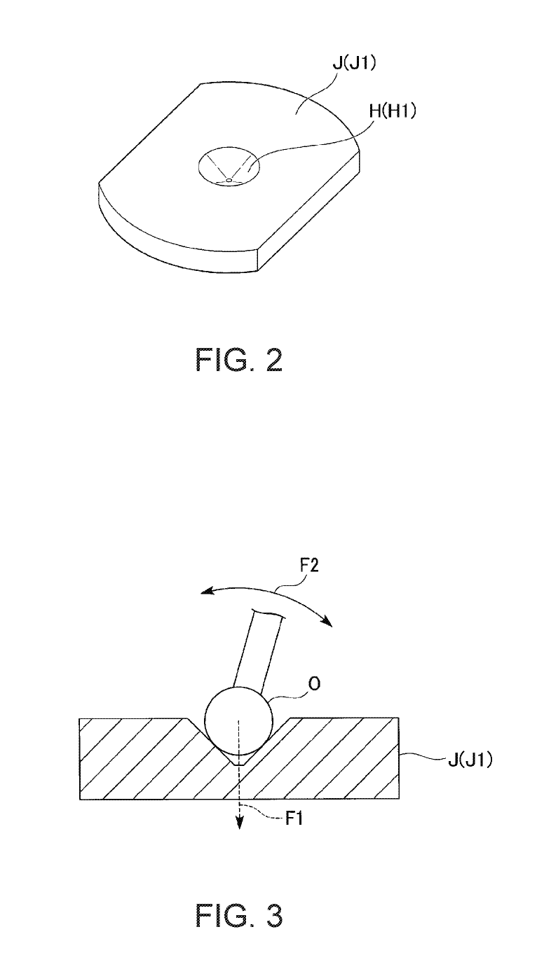

FIG. 2 is a diagram illustrating an example of the jig J1.

In the present embodiment, a description will be made assuming that the jigs J2 and J3 have the same structure as that of the jig J1. The three jigs J may have different structures as long as the depressions H are provided on the upper surfaces of the respective three jigs J. As illustrated in FIG. 2, the conical depression H1 is provided on the upper surface of the jig J1.

The depression H1 may have other shapes as long as the shapes allow an attitude of the TCP to be changed in a state in which a position of the TCP is fixed, and may have, for example, a mortar shape. In this example, the three depressions H have the same structure, but, alternatively, may have different structures. In this case, each of the three depressions H has a shape which allows an attitude of the TCP to be changed in a state in which a position of the TCP is fixed. The jig J is an example of a second member.

When the manipulator is calibrated, the robot system 1 fixes a position of the TCP to a certain position. The robot system 1 uses the jig J in order to fix a position of the TCP to a certain position. The robot system 1 brings a predetermined portion of an end effector provided in the robot 20 into contact with the depression H provided on the upper surface of the jig J. The predetermined portion of the end effector is, for example, a tip of a protruding portion provided at a first end effector END1. A sphere is provided at the tip. A first TCP position is set in the center of the sphere. In a case where the predetermined portion of the end effector comes into contact with the depression H provided on the upper surface of the jig J, a motion of the predetermined portion of the end effector is fixed in a direction along the upper surface of the jig J.

Hereinafter, for convenience of description, causing the predetermined portion of the end effector not to be moved in the direction along the upper surface of the jig J by bring the predetermined portion of the end effector into contact with the depression H will be referred to as fitting a predetermined portion of the first end effector END1 to the depression H. In addition, hereinafter, for convenience of description, a position to which a position of the TCP is fixed in the jig J1 will be referred to as a fixed position X1; a position to which a position of the TCP is fixed in the jig J2 will be referred to as a fixed position X2; and a position to which a position of the TCP is fixed in the jig J3 will be referred to as a fixed position X3. Hereinafter, in a case where the fixed positions X1 to X3 are not required to be differentiated from each other, the fixed positions will be collectively referred to as fixed positions X. In this example, a description will be made of a case where the predetermined portion of the first end effector END1 is a sphere, but the predetermined portion of the first end effector END1 is not necessarily a sphere and may have other shapes as long as a position of the TCP of a first manipulator MNP1 can be fixed to the fixed position X.

In other words, the robot system 1 fits a predetermined portion of the end effector to the depression H in order to fix a position of the TCP to the fixed position X. The robot system 1 causes the robot 20 to perform a calibration information acquisition operation in a state in which the predetermined portion of the end effector is fitted to the depression H.

Here, the state in which the predetermined portion of the end effector is fitted to the depression H indicates a state in which a position of the TCP is fixed to the fixed position X but an attitude of the TCP is not fixed. In this example, an attitude of the TCP of the manipulator is set by using a value matching an attitude of the predetermined portion of the end effector through calculation in a central processing unit (CPU). The attitude of the predetermined portion of the end effector is defined by directions of coordinate axes set for the predetermined portion of the end effector. The attitude of the TCP may be set to match attitudes of other portions.

The calibration information acquisition operation indicates an operation of changing an attitude of the manipulator in a state in which the predetermined portion of the end effector is fitted to the depression H of the jig J. The attitude of the manipulator is designated by each rotation angle of a plurality of actuators of the manipulator.

A position of the TCP is not changed due to the calibration information acquisition operation since the predetermined portion of the end effector is fitted to the depression H. On the other hand, an attitude of the TCP is changed due to the calibration information acquisition operation. As mentioned above, in order to realize a situation in which a position of the TCP is not changed and an attitude of the TCP is changed according to the calibration information acquisition operation, a shape of the predetermined portion of the end effector is preferably a spherical shape, but may be other shapes as long as a position of the TCP is not changed from the fixed position X due to the calibration information acquisition operation.

Here, with reference to FIG. 3, a description will be made of the situation in which a position of the TCP is not changed and an attitude of the TCP is changed according to the calibration information acquisition operation.

FIG. 3 is a diagram illustrating an example of the situation in which a position of the TCP is not changed and an attitude of the TCP is changed according to the calibration information acquisition operation.

The robot system 1 continuously presses a predetermined portion O vertically downward against the upper surface of the jig J with a force F1 in order to maintain a state in which the predetermined portion O of the end effector is fitted to the depression H of the jig J.

At this time, the robot system 1 continuously presses the predetermined portion O with a predetermined magnitude of the force F1 against the depression H so as not to destroy the jig J under the control (for example, compliance control) based on force sensor information acquired from a force sensor. In the above-described way, a position of the TCP is fixed to the fixed position X and thus cannot be moved (fixed) in the direction along the upper surface of the jig J. Therefore, in a case where the end effector is moved, for example, in a direction of an arrow F2 due to the calibration information acquisition operation while maintaining this state, an attitude of the predetermined portion O (that is, an attitude of the TCP) is changed, but a position of the predetermined portion O (that is, a position of the TCP) is not changed.

The robot system 1 causes the robot 20 to perform the calibration information acquisition operation in a state in which the predetermined portion of the end effector is fitted to the depression H, and thus acquires information indicating a rotation angle from an encoder corresponding to each of the plurality of actuators of the manipulator whenever an attitude of the manipulator is changed. The robot system 1 correlates the acquired information indicating a plurality of rotation angles and information indicating an attitude of the manipulator at this time and stores the correlated information as calibration information. The predetermined portion of the end effector may be a portion which can match a position of the TCP, and may be other portions such as predetermined portions of the manipulator. The number of rotation angles related to an attitude of the manipulator is the same as the number of joints of the manipulator.

The robot system 1 repeatedly performs of acquisition of such calibration information for each of the jigs J1 to J3 so as to acquire (store) calibration information corresponding to each of the jigs J1 to J3. Hereinafter, for convenience of description, description will be made assuming that the robot system 1 acquires calibration information in an order of the jigs J1, J2 and J3, but the calibration information is not required to be acquired in this order, and the order of acquiring the calibration information may be any order.

The robot system 1 derives an equation for calculating a position of the TCP for each attitude of the robot 20 by using the forward kinematics on the basis of all pieces of acquired calibration information. The derived equation is an equation which has a rotation angle of each of the actuators acquired from the encoders as an input parameter and has coordinates (three coordinate values) indicating a position of the TCP and a joint offset as the unknowns. A position of the TCP is represented by a robot coordinate system of the manipulator.

The robot system 1 solves simultaneous equations formed of the derived equations so as to calculate coordinates indicating a position of the TCP as the unknown and the joint offset as the unknown. The robot system 1 calibrates the manipulator on the basis of the calculated joint offset. Through the calibration, the robot system. 1 can cause the robot 20 to perform highly accurate work on the manipulator.

Here, a description will be made of the robot 20 and the control apparatus 30 included in the robot system 1. In the present embodiment, as an example, a description will be made of a case where the robot 20 includes two manipulators.

The robot 20 is a double-arm robot including a first moving imaging unit 11, a second moving imaging unit 12, a first fixed imaging unit 21, a second fixed imaging unit 22, a first force sensor 23-1, a second force sensor 23-2, a first end effector END1, a second end effector END2, a first manipulator MNP1, a second manipulator MNP2, and a plurality of actuators (not illustrated). The double-arm robot indicates a robot having two arms, and, in the present embodiment, has two arms such as an arm (hereinafter, referred to as a first arm) constituted of the first end effector END1 and the first manipulator MNP1, and an arm (hereinafter, referred to as a second arm) constituted of the second end effector END2 and the second manipulator MNP2.

The robot 20 may be a single-arm robot instead of the double-arm robot. The single-arm robot indicates a robot having a single arm, and indicates a robot having either the first arm or the second arm. The robot 20 may be a three-or-more arm robot instead of the double-arm robot. The three-or-more arm robot indicates a robot having three or more arms. The robot 20 further includes the control apparatus 30 built thereinto, and is controlled by the built control apparatus 30. The robot 20 may be configured to be controlled by the control apparatus 30 which is externally installed, instead of being configured to include the built control apparatus 30.

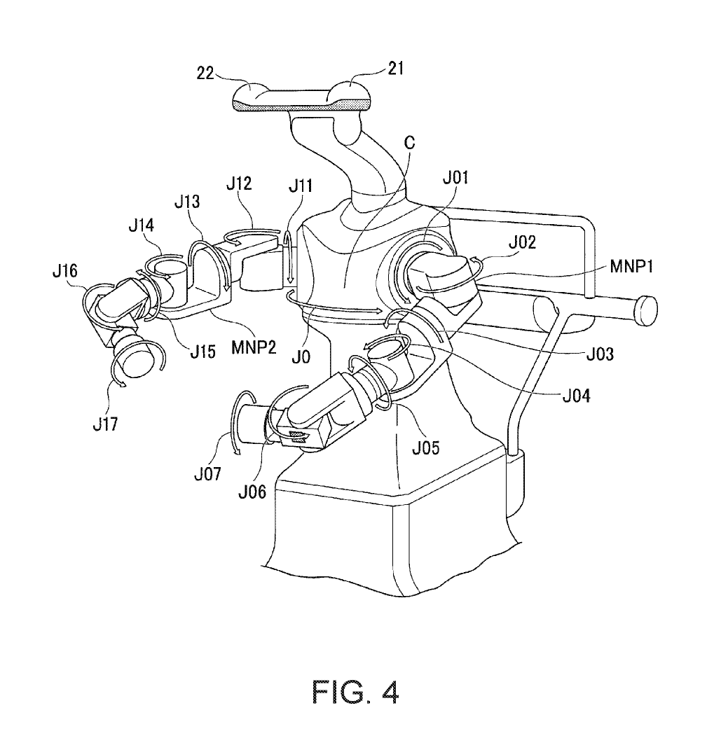

The plurality of actuators may be respectively provided in joints of the first manipulator MNP1 and joints of the second manipulator MNP2. Here, with reference to FIG. 4, a description will be made of each joint of the first manipulator MNP1 and the second manipulator MNP2 provided in the robot 20.

FIG. 4 is a diagram exemplifying respective joints of the first manipulator MNP1 and the second manipulator MNP2 of the robot 20.

As illustrated in FIG. 4, the first manipulator MNP1 includes seven joints indicated by the reference signs J01 to J07, that is, seven actuators.

The second manipulator MNP2 includes seven joints indicated by the reference signs J11 to J17, that is, seven actuators. The joints J01 to J07 and the joints J11 to J17 are respectively rotated along arrows illustrated in FIG. 4. Information indicating a rotation angle of the rotation is output from an encoder related to each actuator.

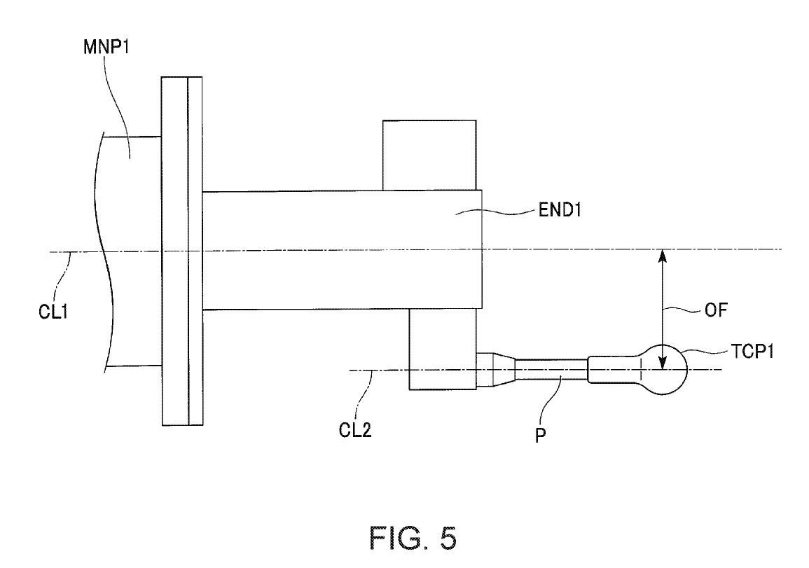

Here, with reference to FIG. 5, a description will be made of the first end effector END1 of the robot 20. The second end effector END2 has the same structure as that of the first end effector END1, and thus description thereof will be omitted.

FIG. 5 is a diagram illustrating an example of the first end effector END1.

As illustrated in FIG. 5, the first end effector END1 is provided with a protruding portion P, and a sphere TCP1 is provided at a tip of the protruding portion P.

The above-described predetermined portion of the end effector indicates the tip sphere. In other words, the predetermined portion of the first end effector END1 indicates the tip sphere TCP1. The tip sphere TCP1 is provided so that a central position of the tip sphere TCP1 matches a position of the TCP of the first manipulator MNP1 (or the position of the TCP of the first manipulator MNP1 matches the central position of the tip sphere TCP1). Hereinafter, a predetermined portion of the second end effector END2 will be referred to as a tip sphere TCP2. Hereinafter, for convenience of description, the central position of the tip sphere TCP1 will be referred to as a position of the tip sphere TCP1, and the central position of the tip sphere TCP2 will be referred to as a position of the tip sphere TCP2.

The protruding portion P is provided at the first end effector END1 so that a central axis CL2 extending in a longitudinal direction of the protruding portion is separated from a central axis CL1 passing through the center of a flange of the first manipulator MNP1 by an offset OF. Hereinafter, a structure in which the central axis CL2 of the tip sphere TCP1 is separated from the central axis CL1 of the first manipulator MNP1 by the offset OF will be referred to as an offset structure.

In the present embodiment, the first end effector END1 is a dedicated end effector for calibrating the first manipulator MNP1, but, alternatively, may be other end effector provided with predetermined portions having the offset structure. The central axis CL1 is a rotation axis of the joint J07 illustrated in FIG. 4 and is an example of a rotation axis of the tip of the arm. The central axis CL1 in the second end effector END2 is a rotation axis of the joint J17 illustrated in FIG. 4 and is an example of a rotation axis of the tip of the arm. The first end effector END1 or the second end effector END2 is an example of a first member. The tip sphere TCP1 or the tip sphere TCP2 is an example of apart of the first member.

FIG. 1 is referred to again. The first arm is a seven-axis vertical articulated arm, and can perform operations of a degree of freedom of seven axes through cooperative operations among a support base, the first manipulator MNP1, and the first end effector END1, using the actuators. The first arm may operate in six or less degrees of freedom (six axes), and may operate in eight or more degrees of freedom (eight axes). The first arm is provided with the first moving imaging unit 11.

The first moving imaging unit 11 is, for example, a camera with a charge coupled device (CCD) or a complementary metal oxide semiconductor (CMOS) which is an imaging element converting collected light into an electric signal.

The first moving imaging unit 11 is communicably connected to the control apparatus 30 via a cable. Wired communication using the cable is performed on the basis of a standard such as Ethernet (registered trademark) or a universal serial bus (USB). The first moving imaging unit 11 and the control apparatus 30 may be connected to each other via wireless communication which is performed on the basis of a communication standard such as Wi-Fi (registered trademark). As illustrated in FIG. 1, the first moving imaging unit 11 is provided at a part of the first manipulator MNP1 constituting the first arm, and can be moved according to movement of the first arm.

The second arm is a seven-axis vertical articulated arm, and can perform operations of a degree of freedom of six axes through cooperative operations among the support base, the second manipulator MNP2, and the second end effector END2, using the actuators. The second arm may operate in six or less degrees of freedom (six axes), and may operate in eight or more degrees of freedom (eight axes). The second arm is provided with the second moving imaging unit 12.

The second moving imaging unit 12 is, for example, a camera with a CCD or a CMOS which is an imaging element converting collected light into an electric signal.

The second moving imaging unit 12 is communicably connected to the control apparatus 30 via a cable. Wired communication using the cable is performed on the basis of a standard such as Ethernet (registered trademark) or a USB. The second moving imaging unit 12 and the control apparatus 30 may be connected to each other via wireless communication which is performed on the basis of a communication standard such as Wi-Fi (registered trademark). As illustrated in FIG. 1, the second moving imaging unit 12 is provided at apart of the second manipulator MNP2 constituting the second arm, and can be moved according to movement of the second arm.

The first fixed imaging unit 21 is, for example, a camera with a CCD or a CMOS which is an imaging element converting collected light into an electric signal. The first fixed imaging unit 21 is communicably connected to the control apparatus 30 via a cable. Wired communication using the cable is performed on the basis of a standard such as Ethernet (registered trademark) or a USB. The first fixed imaging unit 21 and the control apparatus 30 may be connected to each other via wireless communication which is performed on the basis of a communication standard such as Wi-Fi (registered trademark).

The second fixed imaging unit 22 is, for example, a camera with a CCD or a CMOS which is an imaging element converting collected light into an electric signal. The second fixed imaging unit 22 is communicably connected to the control apparatus 30 via a cable. Wired communication using the cable is performed on the basis of a standard such as Ethernet (registered trademark) or a USB. The second fixed imaging unit 22 and the control apparatus 30 may be connected to each other via wireless communication which is performed on the basis of a communication standard such as Wi-Fi (registered trademark).

In the present embodiment, the robot 20 may be configured not to include some or any of the first moving imaging unit 11, the second moving imaging unit 12, the first fixed imaging unit 21, and the second fixed imaging unit 22.

The first force sensor 23-1 is provided between the first end effector END1 and the first manipulator MNP1 of the robot 20. The first force sensor 23-1 detects a force or a moment applied to the first end effector END1. The first force sensor 23-1 outputs information (hereinafter, referred to as force sensor information) indicating the detected force or moment to the control apparatus 30 through communication.

The second force sensor 23-2 is provided between the second end effector END2 and the second manipulator MNP2. The second force sensor 23-2 detects a force or a moment applied to the second end effector END2. The second force sensor 23-2 outputs information (hereinafter, referred to as force sensor information) indicating the detected force or moment to the control apparatus 30 through communication. The force sensor information detected by one or both of the first force sensor 23-1 and the second force sensor 23-2 is used for control on the robot 20, which is performed by the control apparatus 30 on the basis of the force sensor information. Hereinafter, in a case where the first force sensor 23-1 and the second force sensor 23-2 are not required to be differentiated from each other, the sensors will be collectively referred to as force sensors 23. A value indicating the magnitude of a force or the magnitude of a moment included in the force sensor information is an example of an output value of the force sensor.

Each of the first moving imaging unit 11, the second moving imaging unit 12, the first fixed imaging unit 21, the second fixed imaging unit 22, the first force sensor 23-1, the second force sensor 23-2, the first end effector END1, the second end effector END2, the first manipulator MNP1, the second manipulator MNP2, and the plurality of actuators (not illustrated) provided in the robot 20 (hereinafter, referred to as each functional unit of the robot 20) is communicably connected to the control apparatus 30 built into the robot 20 via a cable. Wired communication using the cable is performed on the basis of a standard such as Ethernet (registered trademark) or a USB. Each functional unit of the robot 20 and the control apparatus 30 may be connected to each other via wireless communication which is performed on the basis of a communication standard such as Wi-Fi (registered trademark).

In the present embodiment, each functional unit of the robot 20 acquires a control signal which is input from the control apparatus 30 built into the robot 20, and performs an operation of acquiring information for calibrating the first manipulator MNP1 and the second manipulator MNP2 based on the acquired control signal.

The control apparatus 30 receives an operation such as a jog operation performed by a user, and controls the robot 20 to perform an operation based on the received operation. The control apparatus 30 controls the robot 20 to perform a calibration information acquisition operation. The control apparatus 30 calculates a joint offset for correcting a rotation angle of each of the plurality of actuators of the robot 20 on the basis of the calibration information acquisition operation performed by the robot 20. The control apparatus 30 stores the calculated joint offset.

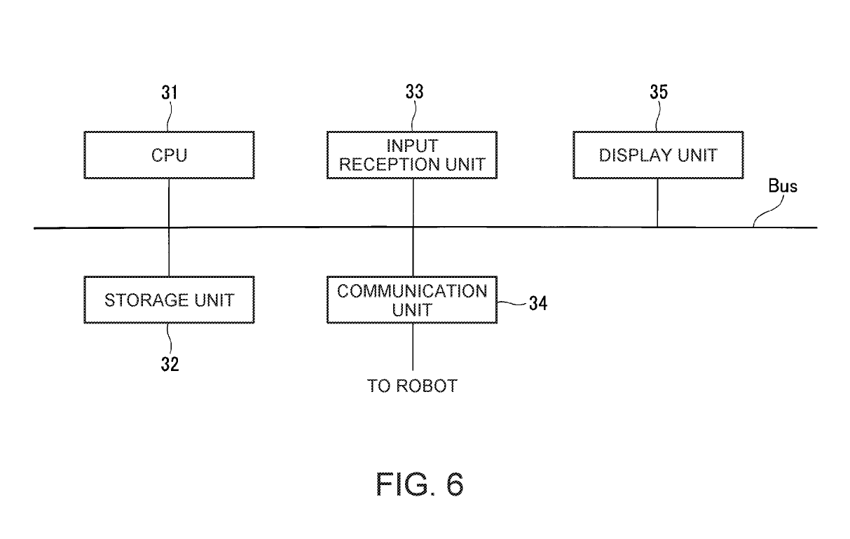

Next, with reference to FIG. 6, a description will be made of a hardware configuration of the control apparatus 30.

FIG. 6 is a diagram illustrating an example of a hardware configuration of the control apparatus 30.

The control apparatus 30 includes, for example, a CPU 31, a storage unit 32, an input reception unit 33, a communication unit 34, and a display unit 35, and performs communication with the robot 20 via the communication unit 34. The constituent elements are communicably connected to each other via a bus Bus. The CPU 31 executes various programs stored in the storage unit 32.

The storage unit 32 includes, for example, a hard disk drive (HDD), a solid state drive (SSD), an electrically erasable programmable read-only memory (EEPROM), a read only memory (ROM), and a random access memory (RAM), and stores various information, images, and programs, processed by the control apparatus 30. The storage unit 32 may be an externally attached storage device which is connected to the control apparatus 30 via a digital input/out port such as a USB, instead of being built thereinto.

The input reception unit 33 is, for example, a keyboard, a mouse, a teaching pendant provided with a touch pad, or other input devices. The input reception unit 33 may be integrally formed with a display unit as a touch panel.

The communication unit 34 is configured to include, for example, a digital input/output port such as a USB, or an Ethernet (registered trademark) port.

The display unit 35 is, for example, a liquid crystal display panel or an organic electroluminescence (EL) display panel.

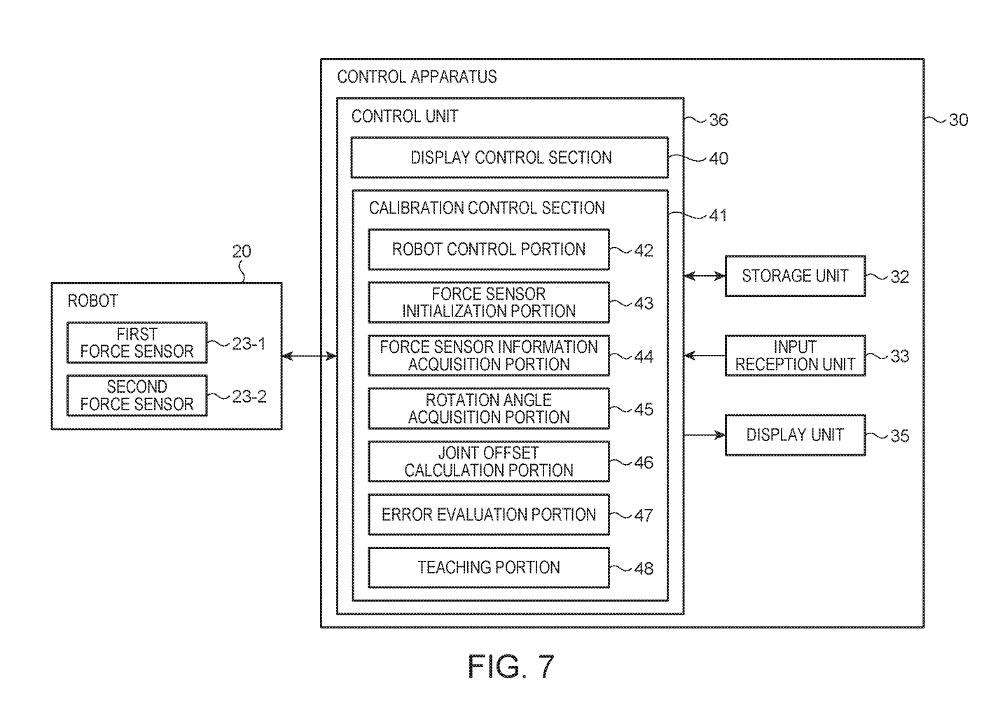

Next, with reference to FIG. 7, a functional configuration of the control apparatus 30 will be described.

FIG. 7 is a diagram illustrating an example of a functional configuration of the control apparatus 30.

The control apparatus 30 includes the storage unit 32, the input reception unit 33, the display unit 35, and a control unit 36. Some or all functional portions of the control unit 36 are realized by, for example, the CPU 31 executing various programs stored in the storage unit 32. Some or all of the functional portions may be hardware functional portions such as large scale integration (LSI) or an application specific integrated circuit (ASIC).

The control unit 36 controls the entire control apparatus 30. The control unit 36 includes a display control section 40 and a calibration control section 41.

The display control section 40 generates a graphical user interface (GUI) assisting an operation performed by a user in a manipulator calibration process, and displays the generated GUI on the display unit 35. The GUI includes, for example, a button for starting the manipulator calibration process or a jog dial for performing a jog operation on the robot 20.

The calibration control section 41 includes a robot control portion 42, a force sensor initialization portion 43, a force sensor information acquisition portion 44, a rotation angle acquisition portion 45, a joint offset calculation portion 46, an error evaluation portion 47, and a teaching portion 48. The calibration control section 41 controls all processes related to calibration of the first manipulator MNP1 and the second manipulator MNP2.

More specifically, the calibration control section 41 causes the robot control portion 42 to move the robot 20 on the basis of an operation (for example, a jog operation via the GUI) received from the input reception unit 33. In the present embodiment, a description is made of a case where the calibration control section 41 receives an operation from the input reception unit 33 via the GUI, but the calibration control section 41 may receive an operation via a switch or a button without using the GUI. The GUI includes a jog screen for moving the robot 20, a button for starting an operation of acquiring information for calibrating the first manipulator MNP1, a button for starting an operation of acquiring information for calibrating the second manipulator MNP2, and the like.

The robot control portion 42 operates the robot 20 in response to a request from the calibration control section 41. The robot control portion 42 acquires force sensor information detected by the force sensor 23 from the force sensor information acquisition portion 44, and controls the robot 20 according to control based on the acquired force sensor information.

The force sensor initialization portion 43 sets (initializes) a zero point of force sensor information detected by the force sensor 23. For example, in a state in which only gravity is detected by the force sensor 23, the force sensor initialization portion 43 sets the magnitude of gravity detected by the force sensor 23 as a zero point. Hereinafter, this process will be referred to as initialization of the force sensor 23.

The force sensor information acquisition portion 44 acquires force sensor information detected by the force sensor 23. The force sensor information acquisition portion 44 outputs the acquired force sensor information to the robot control portion 42.

The rotation angle acquisition portion 45 acquires information indicating rotation angles from the encoders related to the plurality of actuators of the first manipulator MNP1. The rotation angle acquisition portion 45 correlates information indicating the plurality of acquired rotation angles with information (for example, an ID for identifying an attitude) indicating an attitude of the first manipulator MNP1 at this time, and stores the correlated information in the storage unit 32 as calibration information. The information indicating the rotation angles indicates an attitude of the first manipulator MNP1. In a case where there are a plurality of jigs J, in the calibration information, information indicating the depression H of the jig J to which the tip sphere TCP1 is fitted is correlated with the information indicating the plurality of rotation angles. The information indicating the depression H of the jig J is, for example, an ID or the like for identifying each depressions H, but may be other information as long as each depression H can be identified. The rotation angle acquisition portion 45 performs the same process as the process on the first manipulator MNP1, on the second manipulator MNP2.

The joint offset calculation portion 46 acquires the calibration information stored in the storage unit 32. The joint offset calculation portion 46 calculates a joint offset for correcting a rotation angle of each of the plurality of actuators of the first manipulator MNP1 and the second manipulator MNP2 on the basis of the acquired calibration information. The joint offset calculation portion 46 stores information indicating the calculated joint offset in the storage unit 32.

The error evaluation portion 47 reads the calibration information related to the first manipulator MNP1 stored in the storage unit 32 one by one, and calculates a position of the TCP of the first manipulator MNP1 according to the forward kinematics based on the information indicating a rotation angle included in the calibration information and the information indicating a joint offset stored in the storage unit 32 for each piece of read calibration information.

The error evaluation portion 47 calculates an amount indicating the degree of variation among the positions of the TCP of the first manipulator MNP1 on the basis of the positions of the TCP of the first manipulator MNP1 calculated for each piece of the calibration information (that is, for each attitude of the robot 20). Hereinafter, as an example, a description will be made of a case where the amount indicating the variation degree is a standard deviation. In other words, the error evaluation portion 47 calculates a standard deviation of the positions of the TCP of the first manipulator MNP1 as a first standard deviation on the basis of all the positions of the TCP of the first manipulator MNP1 calculated for each piece of the calibration information. The amount indicating the variation degree may be, for example, a variance or a standard error instead of the standard deviation. The error evaluation portion 47 determines (evaluates) whether or not the calculated first standard deviation is equal to or less than a predetermined value.

The error evaluation portion 47 reads calibration information related to the second manipulator MNP2 stored in the storage unit 32 one by one, and calculates a position of the TCP of the second manipulator MNP2 according to the forward kinematics based on the information indicating a rotation angle included in the calibration information and the information indicating a joint offset stored in the storage unit 32 for each piece of read calibration information. The error evaluation portion 47 calculates a standard deviation of the positions of the TCP of the second manipulator MNP2 as a second standard deviation on the basis of the positions of the TCP of the second manipulator MNP2 calculated for each piece of the calibration information (that is, for each attitude of the robot 20). The error evaluation portion 47 determines (evaluates) whether or not the calculated second standard deviation is less than a predetermined value.

If the error evaluation portion 47 determines that both of the first standard deviation and the second standard deviation calculated by the error evaluation portion 47 are less than a predetermined value Y1, the teaching portion 48 stores a joint offset for correcting each rotation angle of the plurality of actuators of the first manipulator MNP1 and the second manipulator MNP2 in the storage unit 32. The teaching portion 48 may be configured to determine whether or not the first standard deviation is equal to or less than the predetermined value Y1, and determines whether or not the second standard deviation is equal to or less than a predetermined value Y2 which is different from the predetermined value Y1.

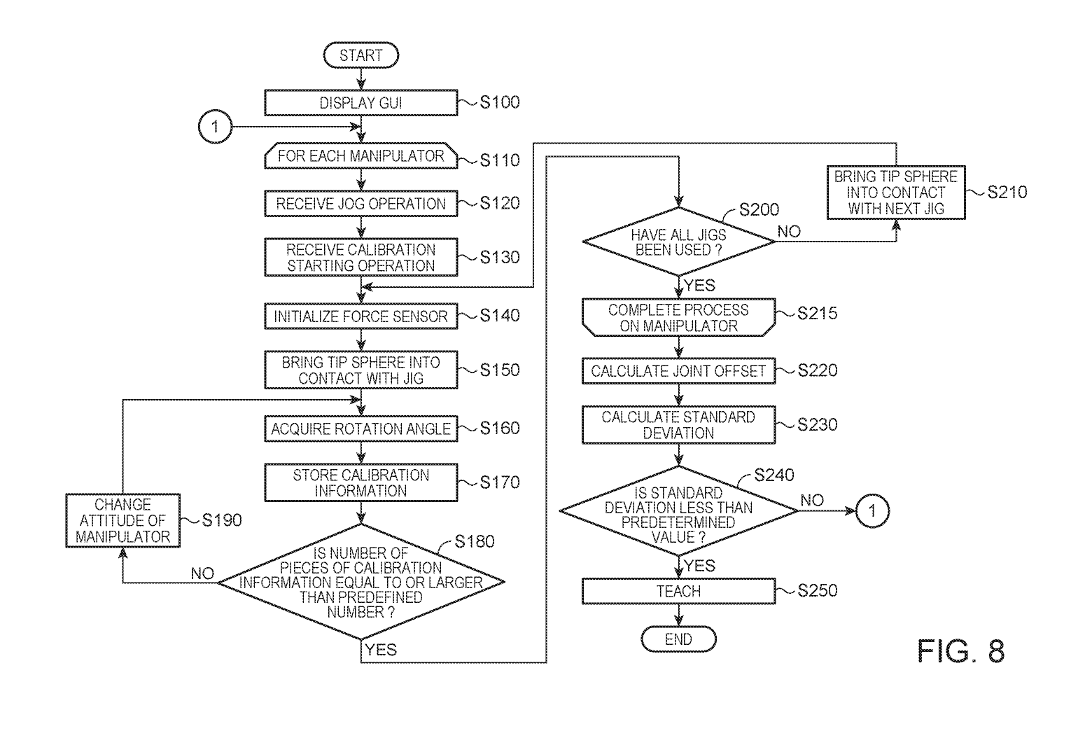

Hereinafter, with reference to FIG. 8, a description will be made of processes until the control apparatus 30 completes calibration of the first manipulator MNP1 and the second manipulator MNP2.

FIG. 8 is a flowchart illustrating an example of a flow of processes until the control apparatus 30 completes calibration of the first manipulator MNP1 and the second manipulator MNP2.

First, the display control section 40 displays a GUI assisting an operation performed by a user on the display unit 35 in the manipulator calibration process (step S100).

Next, the control unit 36 repeatedly performs processes in steps S120 to S210 on each manipulator (that is, the first manipulator MNP1 and the second manipulator MNP2) of the robot 20 (step S110). Hereinafter, for convenience of description, the description will be made of a case where the processes in steps S120 to S210 are initially performed on the first manipulator MNP1, and then the processes in steps S120 to S210 are performed on the second manipulator MNP2.

For this reason, the processes in steps S120 to S210 will be described focusing on processes on the first manipulator MNP1. The control unit 36 may be configured to initially perform the processes in steps S120 to S210 on the second manipulator MNP2 and then perform the processes in steps S120 to S210 on the first manipulator MNP1.

The robot control portion 42 moves the first manipulator MNP1, for example, until the tip sphere TCP1 of the first end effector END1 is fitted to any one of the depressions H of the three jigs J on the basis of a user's jog operation received from the input reception unit 33 via the GUI displayed on the display unit 35 in step S100 (step S120).

Here, first, it is assumed that the robot control portion 42 causes the tip sphere TCP1 of the first end effector END1 to the depression H1 of the jig J1 on the basis of the user's jog operation. As will be described below, the robot control portion 42 performs processes in steps S130 to S200 in a state in which the tip sphere TCP1 of the first end effector END1 is fitted to the depression H1 of the jig J1. The robot control portion 42 repeatedly performs the processes in steps S130 to S200 in an order of the jigs J1, J2 and J3. This order is only an example and may be other orders.

Next, the calibration control section 41 receives an operation for starting a calibration process on the first manipulator MNP1 (for example, clicking a button for starting the calibration process on the first manipulator MNP1) from the input reception unit 33 via the GUI displayed on the display unit 35 in step S100 (step S130). Next, the robot control portion 42 moves the tip sphere TCP1 fitted to the depression H1 of the jig J1 in a predetermined direction from the depression H1 of the jig J1 by a predetermined distance. The force sensor initialization portion 43 initializes the first force sensor 23-1 at this time (step S140).

The predetermined direction is a vertically upward direction but may be other directions. The predetermined distance may be a distance by which the tip sphere TCP1 is separated from the depression H1 of the jig J1, but is preferably a distance which does not cause a deviation in a position of the tip sphere TCP1 in a direction along the upper surface of the jig J1 provided with the depression H1 due to vibration while the tip sphere TCP1 is being separated from the depression H1 of the jig J1 (alternatively, even if the deviation occurs, the tip sphere TCP1 can be easily returned to a position before being deviated by causing the tip sphere TCP1 to be located along an inner wall of the depression H1 according to control based on force sensor information, such as compliance control). The deviation in a position of the tip sphere TCP1 in the direction along the upper surface of the jig J while the tip sphere TCP1 is being separated from the depression H of the jig J may be caused by an error generated when a position of the tip sphere TCP1 is moved due to a joint offset for correcting a rotation angle of each actuator being not calculated in this step, or fluctuation (change) in a value of the force sensor 23, in addition to vibration of the tip sphere TCP1.

The robot control portion 42 moves the tip sphere TCP1 fitted to the depression H1 of the jig J1 in the predetermined direction from the depression H1 of the jig J1 by the predetermined distance, and then waits for vibration of the tip sphere TCP1 (or the first manipulator MNP1) to be reduced. More specifically, in this waiting, the robot control portion 42 waits for a predetermined period of time to elapse and then proceeds to the process in step S150, but, alternatively, the number of vibration per unit time of the first manipulator MNP1 may be measured by the force sensor 23, and the robot control portion 42 may wait for the measured number of vibration to be equal to or less than a threshold value.

Next, the robot control portion 42 moves the tip sphere TCP1 in an opposite direction to the predetermined direction in step S140 in order to fit the tip sphere TCP1 to the depression H1 of the jig J1 again. At this time, the robot control portion 42 acquires force sensor information from the force sensor information acquisition portion 44, and moves the tip sphere TCP1 until the tip sphere TCP1 is fitted to the depression H1 of the jig J1 according to control based on the force sensor information (step S150). After a position of the tip sphere TCP1 is fitted to the depression H1 of the jig J1, the robot control portion 42 applies a predetermined magnitude of force to the tip sphere TCP1 fitted to the depression H1 vertically downward. The robot control portion 42 performs processes in steps S160 to S200 while maintaining the state in which the predetermined magnitude of force is applied in the opposite direction to the predetermined direction in step S140.

Next, the rotation angle acquisition portion 45 acquires information indicating a rotation angle from an encoder related to each of the plurality of actuators of the first manipulator MNP1 (step S160). When the information indicating a rotation angle from an encoder related to each of the plurality of actuators of the first manipulator MNP1 is acquired, the robot control portion 42 measures the number of vibration per unit time of the first manipulator MNP1 by using the first force sensor 23-1, and waits for the measured number of vibration to be a threshold value or less. Consequently, the robot control portion 42 can prevent a rotation angle of each actuator from being changed due to the vibration of the first manipulator MNP1. Next, the rotation angle acquisition portion 45 stores calibration information in which information indicating a current attitude of the first manipulator MNP1 is correlated with the information indicating the rotation angle acquired in step S160 in the storage unit (step S170). Next, the calibration control section 41 determines whether or not the number of pieces of calibration information stored in the storage unit 32 is equal to or larger than a predefined number (step S180).

Here, the predefined number may be equal to or larger than the number of unknowns used to calculate a joint offset in the joint offset calculation portion 46, and is assumed to be 13 in this example. The calibration information is preferably acquired so that the plurality of actuators of the first manipulator MNP1 are moved at predetermined angles or more due to a changed attitude in step S190.

If the calibration control section 41 determines that the number of pieces of calibration information stored in the storage unit 32 is not equal to or larger than the predefined number in step S180 (NO in step S180), the robot control portion 42 controls the robot 20 to change an attitude of the first manipulator MNP1 to the next attitude (step S190), and then performs processes in steps S160 to S180 in the changed attitude of the first manipulator MNP1.

Here, when changing an attitude of the first manipulator MNP1 to the next attitude, the robot control portion 42 may read the information indicating the attitude of the first manipulator MNP1 in order and may change the attitude of the first manipulator MNP1 in the reading order, and may change the attitude of the first manipulator MNP1 at random. Hereinafter, a description will be made of a case where the robot control portion 42 reads the information indicating an attitude stored in the storage unit 32 in order and changes the attitude of the first manipulator MNP1 in the reading order. Each of an attitude of the first manipulator MNP1 or an attitude of the second manipulator MNP2 is an example of an attitude of the arm. When changing the attitude of the first manipulator MNP1 to an attitude included in a first attitude, the robot control portion 42 changes the attitude according to compliance control. Consequently, the robot control portion 42 can change an attitude of the first manipulator MNP1 without destroying each member constituting the first end effector END1, the jig J, or the first manipulator MNP1.

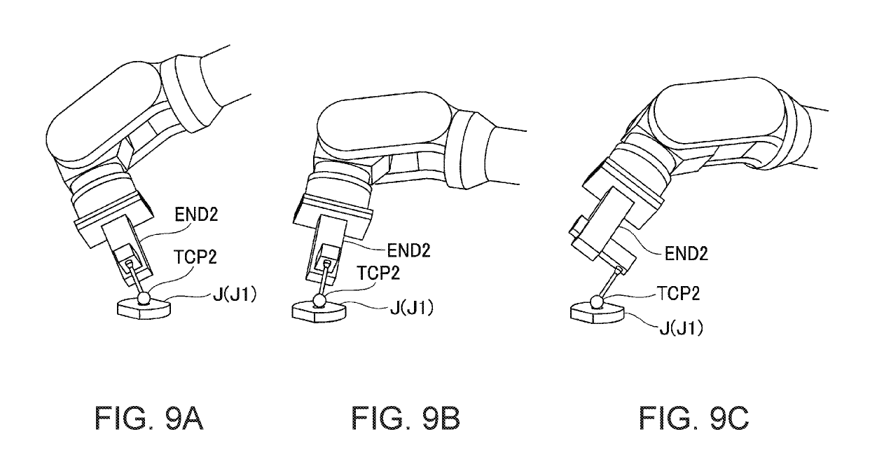

Here, with reference to FIGS. 9A to 9C, a description will be made of a process in which the robot control portion 42 changes an attitude of the first manipulator MNP1 in step S190.

FIGS. 9A to 9C are diagrams exemplifying attitudes of the first manipulator MNP1. FIG. 9A illustrates an example of an attitude of the first manipulator MNP1. FIG. 9B illustrates another example of an attitude of the first manipulator MNP1. FIG. 9C illustrates still another example of an attitude of the first manipulator MNP1.

While maintaining a state in which the tip sphere TCP1 is fitted to the depression H of the jig J, the robot control portion 42 changes an attitude of the first manipulator MNP1 from the attitude of the first manipulator MNP1 illustrated in FIG. 9A to the attitude of the first manipulator MNP1 illustrated in FIG. 9B or 9C. Since the attitude is changed in the above-described way, it is possible to acquire a plurality of rotation angles which are different from each other for each attitude of the first manipulator MNP1 and each rotation angle of the plurality of actuators of the first manipulator MNP1 without changing a position of the TCP of the first manipulator MNP1 which is set to the center of the tip sphere TCP1 from the fixed position X.

On the other hand, the calibration control section determines that the number of pieces of calibration information stored in the storage unit 32 is equal to or larger than the predefined number in step S180 (YES in step S180), the robot control portion 42 determines whether or not the processes insteps S140 to S190 have been repeatedly performed on all the jigs J1 to J3 (step S200). The processes in steps S140 to S190 are examples of processes in which the above-described calibration information acquisition operation is performed by each of the first manipulator MNP1 and the second manipulator MNP2.

If it is determined that processes in steps S140 to S190 have not been repeatedly performed on all the jigs J1 to J3 (NO in step S200), the robot control portion 42 reads information indicating relative positions of the depressions H1 to H3 provided on the respective upper surfaces of the jigs J1, J2 and J3 from the storage unit 32. The robot control portion 42 moves the tip sphere TCP1 until the tip sphere TCP1 is fitted to the depression H of the next jig (in this example, the jig J2) on the basis of the read information indicating relative positions of the depressions H1 to H3 (step S210). Thereafter, the force sensor initialization portion 43 returns to step S140 and initializes the first force sensor 23-1.

On the other hand, it is determined that processes in steps S140 to S190 have been repeatedly performed on all the jigs J1 to J3 (YES in step S200), the robot control portion 42 returns to step S110, and performs the processes in steps S120 to S210 on the second manipulator MNP2 again (step S215). After the processes on the second manipulator MNP2 are completed, the joint offset calculation portion 46 reads all of the pieces of calibration information stored in the storage unit 32. The joint offset calculation portion 46 reads the information indicating relative positions of the depressions H1 to H3. The joint offset calculation portion 46 calculates joint offsets related to the plurality of actuators of each of the first manipulator MNP1 and the second manipulator MNP2 on the basis of the read calibration information and the read information indicating relative positions of the depressions H1 to H3, and stores the calculated joint offsets in the storage unit 32 (step S220).

Storing of the information indicating the joint offsets in the storage unit 32 in step S220 is temporary storing for using the joint offsets in a process in step S230 and is different from the above-described teaching of a joint offset.

Here, a description will be made of a process of calculating the joint offset in the joint offset calculation portion 46. In the forward kinematics, an equation for calculating a position and an attitude of the TCP of the first manipulator MNP1 is obtained for each piece of calibration information related to the first manipulator MNP1 (that is, a combination of a position of each depression H and an attitude of the first manipulator MNP1). Input parameters of the equation for calculating a position and an attitude of the TCP of the first manipulator MNP1 are rotation angles of the plurality of actuators of the first manipulator MNP1.

The unknowns of the equation for calculating a position and an attitude of the TCP of the first manipulator MNP1 are joint offsets (seven joint offsets) for correcting the respective rotation angles of the plurality of actuators of the first manipulator MNP1, coordinates (nine coordinate values) indicating positions of the TCP of the first manipulator MNP1 at the respective depressions H1 to H3, and angles (three angle values) indicating an attitude of the TCP of the first manipulator MNP1. The joint offset calculation portion 46 is not required to calculate all the unknowns from the equation for calculating a position of the TCP of the first manipulator MNP1. For example, in a case of outputting mechanical accuracy regarding a position of the TCP of the first manipulator MNP1, it is not necessary to calculate the position of the TCP of the first manipulator MNP1.

Here, a position (that is, the fixed position X1) of the TCP of the first manipulator MNP1 at the depression H1, a position (that is, the fixed position X2) of the TCP of the first manipulator MNP1 at the depression H2, and a position (that is, the fixed position X3) of the TCP of the first manipulator MNP1 at the depression H3 may be represented by a position of any one of the depressions H1 to H3 on the basis of the information indicating relative positions of the depressions H1 to H3. In other words, coordinates indicating a position of the TCP of the first manipulator MNP1 at each of the depressions H1 to H3 may be represented by three coordinate values. In the present embodiment, a position of the TCP of the first manipulator MNP1 at the depression H1, a position of the TCP of the first manipulator MNP1 at the depression H2, and a position of the TCP of the first manipulator MNP1 at the depression H3 are indicated by coordinates of the fixed position X1, but may be represented by a position of the fixed position X2 or the fixed position X3.

On the other hand, in the forward kinematics, an equation for calculating a position and an attitude of the TCP of the second manipulator MNP2 is obtained for each piece of calibration information related to the second manipulator MNP2 (that is, a combination of a position of each depression H and an attitude of the second manipulator MNP2). Input parameters of the equation for calculating a position and an attitude of the TCP of the second manipulator MNP2 are rotation angles of the plurality of actuators of the second manipulator MNP2.

The unknowns of the equation for calculating a position and an attitude of the TCP of the second manipulator MNP2 are joint offsets (seven joint offsets) for correcting the respective rotation angles of the plurality of actuators of the second manipulator MNP2, coordinates (nine coordinate values) indicating positions of the TCP of the second manipulator MNP2 at the respective depressions H1 to H3, and angles (three angle values) indicating an attitude of the TCP of the second manipulator MNP2. The joint offset calculation portion 46 is not required to calculate all the unknowns from the equation for calculating a position of the TCP of the second manipulator MNP2. For example, in a case of outputting mechanical accuracy regarding a position of the TCP of the second manipulator MNP2, it is not necessary to calculate the position of the TCP of the second manipulator MNP2.

Here, in the same manner as in the case of the first manipulator MNP1, a position (that is, the fixed position X1) of the TCP of the second manipulator MNP2 at the depression H1, a position (that is, the fixed position X2) of the TCP of the second manipulator MNP2 at the depression H2, and a position (that is, the fixed position X3) of the TCP of the second manipulator MNP2 at the depression H3 may be represented by a position of any one of the depressions H1 to H3 on the basis of the information indicating relative positions of the depressions H1 to H3. In other words, coordinates indicating a position of the TCP of the second manipulator MNP2 at each of the depressions H1 to H3 may be represented by three coordinate values.

In the present embodiment, a position of the TCP of the second manipulator MNP2 at the depression H1, a position of the TCP of the second manipulator MNP2 at the depression H2, and a position of the TCP of the second manipulator MNP2 at the depression H3 are indicated by coordinates of the fixed position X1, but may be represented by a position of the fixed position X2 or the fixed position X3. However, a position of the TCP of the first manipulator MNP1 and a position of the TCP of the second manipulator MNP2 are calculated by solving simultaneous equations, and thus any one of the fixed positions X1 to X3 are necessarily common.

As described above, positions of the TCP included in a plurality of equations related to the first manipulator MNP1 and a plurality of equations related to the second manipulator MNP2 are represented by the same variable. By the use of the variable, by solving simultaneous equations formed of the plurality of equations related to the first manipulator MNP1 and the plurality of equations related to the second manipulator MNP2 according to nonlinear optimization computation such as a steepest descent method, a Newton method, or a Levenberg-Marquardt method, it is possible to calculate both a joint offset for correcting each rotation angle of the plurality of actuators of the first manipulator MNP1 and a joint offset for correcting each rotation angle of the plurality of actuators of the second manipulator MNP2.

Therefore, the joint offset calculation portion 46 derives the plurality of equations related to the first manipulator MNP1 and the plurality of equations related to the second manipulator MNP2 on the basis of the calibration information read from the storage unit 32, and collectively solves the simultaneous equations on the basis of the derived equations according to nonlinear optimization computation such as a steepest descent method, a Newton method, or a Levenberg-Marquardt method so as to calculate both of the joint offset for correcting each rotation angle of the plurality of actuators of the first manipulator MNP1 and the joint offset for correcting each rotation angle of the plurality of actuators of the second manipulator MNP2.

Consequently, the joint offset calculation portion 46 can improve accuracy of cooperative work of the first manipulator MNP1 and the second manipulator MNP2. The cooperative work is work performed by both of the first manipulator MNP1 and the second manipulator MNP2 after a position of the TCP of the first manipulator MNP1 and a position of the TCP of the second manipulator MNP2 are moved to the same position.

By using the method of calculating joint offsets by collectively solving the simultaneous equations based on the calibration information which is obtained by fixing a position of the TCP of the manipulator to each of a plurality of points (three points are used in this example, but two or more points may be used) whose relative positions are known, it is possible to prevent a joint offset for correcting a rotation angle of an actuator at the base (an end on an opposite side to the side on which the end effector is provided) of the manipulator from being undefined, and thus the robot system 1 can calculate all joint offsets regarding each rotation angle of the plurality of actuators of the manipulator.

Next, the error evaluation portion 47 reads the information indicating the joint offsets related to the first manipulator MNP1, stored in the storage unit 32 in step S220, from the storage unit 32. The error evaluation portion 47 reads the calibration information related to the first manipulator MNP1 calculated in step S170 from the storage unit 32 one by one, and calculates a position of the TCP of the first manipulator MNP1 according to the forward kinematics based on the rotation angles included in the calibration information and the read joint offsets for each piece of read calibration information. The error evaluation portion 47 calculates a standard deviation of the positions of the TCP of the first manipulator MNP1 as a first standard deviation on the basis of all the positions of the TCP of the first manipulator MNP1 calculated for each piece of the calibration information (that is, for each attitude of the first manipulator MNP1).

Next, the error evaluation portion 47 reads the information indicating the joint offsets related to the second manipulator MNP2, stored in the storage unit 32 in step S220, from the storage unit 32. The error evaluation portion 47 reads the calibration information related to the second manipulator MNP2 calculated in step S170 from the storage unit 32 one by one, and calculates a position of the TCP of the second manipulator MNP2 according to the forward kinematics based on the rotation angles included in the calibration information and the read joint offsets for each piece of read calibration information. The error evaluation portion 47 calculates a standard deviation of the positions of the TCP of the second manipulator MNP2 as a second standard deviation on the basis of all the positions of the TCP of the second manipulator MNP2 calculated for each piece of the calibration information (that is, for each attitude of the second manipulator MNP2) (step S230).

Next, the error evaluation portion 47 determines (evaluates) whether or not both of the first standard deviation calculated in step S230 and the second standard deviation calculated in step S230 are less than a predetermined value Y1 (step S240). If it is determined that one of the first standard deviation calculated in step S230 and the second standard deviation calculated in step S230 is not less than the predetermined value Y1 (NO in step S240), the robot control portion 42 returns to step S110 and acquires calibration information related to the first manipulator MNP1 and the second manipulator MNP2 again so as to calculate joint offsets again.

On the other hand, if the error evaluation portion 47 determines that both of the first standard deviation calculated in step S230 and the second standard deviation calculated in step S230 are less than the predetermined value Y1 (YES in step S240), the teaching portion 48 stores the joint offsets calculated in step S220 in the storage unit 32 (step S250). In the present embodiment, the teaching portion 48 is configured to determine whether or not the first standard deviation calculated in step S230 and the second standard deviation calculated in step S230 are less than the predetermined value Y1, but, alternatively, if the error evaluation portion 47 determines that one of the first standard deviation calculated in step S230 and the second standard deviation calculated in step S230 is less than the predetermined value Y1, the joint offsets calculated in step S220 may be stored (taught) in (to) the storage unit 32.

The robot control portion 42 acquires the information indicating a rotation angle of each actuator by changing an attitude of the first manipulator MNP1 while maintaining a state in which the tip sphere TCP1 is fitted to the depression H of the jig J, that is, comes into contact with the depression H of the jig J in the processes in steps S150 to S210, but, alternatively, may acquire the information indicating a rotation angle of each actuator by changing an attitude of the first manipulator MNP1 while maintaining a state in which the depression H and the tip sphere TCP1 are separated from each other by a predetermined distance. In this case, the robot control portion 42 changes an attitude of the first manipulator MNP1 so that a relative positional relationship between the tip sphere TCP1 and the depression H is not changed (that is, the relative positional relationship is fixed).

The robot control portion 42 acquires the information indicating a rotation angle of each actuator by changing an attitude of the second manipulator MNP2 while maintaining a state in which the tip sphere TCP2 is fitted to the depression H of the jig J, that is, comes into contact with the depression H of the jig J in the processes in steps S150 to S210, but, alternatively, may acquire the information indicating a rotation angle of each actuator by changing an attitude of the second manipulator MNP2 while maintaining a state in which the depression H and the tip sphere TCP2 are separated from each other by a predetermined distance. In this case, the robot control portion 42 changes an attitude of the second manipulator MNP2 so that a relative positional relationship between the tip sphere TCP2 and the depression H is not changed (that is, the relative positional relationship is fixed). A distance between the tip sphere TCP1 (or the tip sphere TCP2) and the depression H when a relative positional relationship between the tip sphere TCP1 (or the tip sphere TCP2) and the depression H is fixed is an example of a distance of 1.

As described above, in the present embodiment, the robot system 1 calibrates the first manipulator MNP1 (or the second manipulator MNP2) by causing the first manipulator MNP1 (or the second manipulator MNP2) to take a plurality of attitudes on the basis of force sensor information acquired from at least the force sensor 23 in a state in which the tip sphere TCP1 (or the tip sphere TCP2) is moved so that a distance between the tip sphere TCP1 (or the tip sphere TCP2) and the jig J becomes the distance of 1 for each of a plurality of (three in this example) jigs J. Consequently, the robot system 1 can easily calibrate the manipulator.

The robot system 1 calibrates the first manipulator MNP1 (or the second manipulator MNP2) by causing the first manipulator MNP1 (or the second manipulator MNP2) to take a plurality of attitudes on the basis of force sensor information acquired from at least the force sensor 23 in a state in which the tip sphere TCP1 (or the tip sphere TCP2) is moved so that a distance between the tip sphere TCP1 (or the tip sphere TCP2) and the jig J becomes a distance of substantially 0 for each of a plurality of jigs J. Consequently, the robot system 1 can calibrate the first manipulator MNP1 (second manipulator MNP2) by causing the first manipulator MNP1 (second manipulator MNP2) to take one or more attitudes while maintaining a state in which the tip sphere TCP1 (tip sphere TCP2) is in contact with the jig J.

For each of the plurality of jigs J, the robot system 1 moves the tip sphere TCP1 (tip sphere TCP2) so that a distance between the tip sphere TCP1 (tip sphere TCP2) and the jig J becomes the distance of 1, then initializes the force sensor 23 by moving tip sphere TCP1 (tip sphere TCP2) so that a distance between the tip sphere TCP1 (tip sphere TCP2) and the jig J becomes a distance which is different from the distance of 1, and then also moves the tip sphere TCP1 (tip sphere TCP2) again so that a distance between the tip sphere TCP1 (tip sphere TCP2) and the jig J becomes the distance of 1. Consequently, the robot system 1 can minimize errors caused by an external force such as gravity applied to the force sensor 23.

When the force sensor 23 is initialized, the robot system 1 waits for vibration of the first end effector END1 (or the second end effector END2) to be reduced, then initializes the force sensor 23, and moves the tip sphere TCP1 (tip sphere TCP2) so that a distance between the tip sphere TCP1 (tip sphere TCP2) and the jig J becomes the distance of 1. Consequently, the robot system 1 can minimize errors in initialization of the force sensor 23, caused by vibration of the tip sphere TCP1 (or the tip sphere TCP2).

The robot system 1 causes the first manipulator MNP1 (or the second manipulator MNP2) to take a plurality of attitudes in a state in which the tip sphere TCP1 (or the tip sphere TCP2) is in contact with the depression H of the jig J. Consequently, the robot system 1 can cause the first manipulator MNP1 (or the second manipulator MNP2) to take a plurality of attitudes in a state in which a position of the tip sphere TCP1 (or the tip sphere TCP2) is fixed, and can thus calibrate a rotation angle of the actuator for controlling the first manipulator MNP1 (or the second manipulator MNP2) by using the joint offset.

The robot system 1 collectively calibrates the first manipulator MNP1 and the second manipulator MNP2. Consequently, the robot system 1 can improve accuracy of cooperative work between the first manipulator MNP1 and the second manipulator MNP2.

### Second Embodiment

Hereinafter, a second embodiment will be described with reference to the drawings.

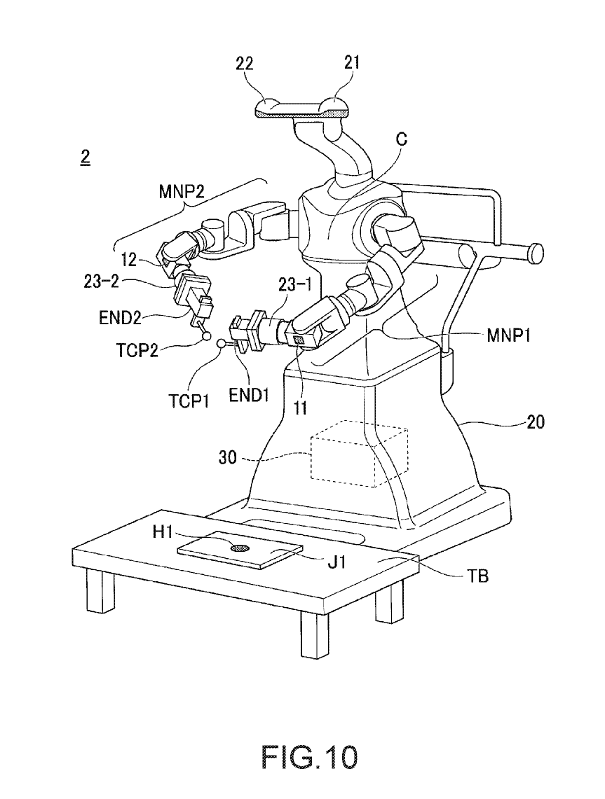

FIG. 10 is a configuration diagram illustrating an example of a robot system 2 according to the present embodiment. In the second embodiment, the same constituent elements as in the first embodiment are given the same reference numerals, and description thereof will be omitted.

The robot system 2 includes a robot 20 and a control apparatus 30. The robot system 2 calibrates manipulators included in the robot 20 by using a jig J1 illustrated in FIG. 10. Here, a description will be made of calibration of the manipulator performed by the robot system 2. The robot system 2 acquires information indicating a rotation angle of each of a plurality of actuators provided in the manipulator of the robot 20, from an encoder connected to (or included in) each actuator. Hereinafter, for convenience of description, the rotation angle of the actuator will be simply referred to as a rotation angle in some cases.

In the robot system 2, the control apparatus 30 calculates a current position of a TCP of the manipulator by using the rotation angle acquired from each encoder on the basis of the forward kinematics. Hereinafter, for convenience of description, a position of the TCP of the manipulator will be simply referred to as a position of the TCP. The robot system 2 controls the robot 20 to perform various pieces of work by using the manipulator on the basis of the calculated position of the TCP.

However, the calculated position of the TCP may indicate a position which is different from an actual position of the TCP due to errors caused by elasticity of a member constituting the manipulator or errors related to rotation of the actuator.

Hereinafter, the value η for correcting a rotation angle of the actuator as shown in Equation (1) will be referred to as a joint offset. Therefore, the calibration of the manipulator performed by the robot system 2 indicates that a joint offset is calculated for each rotation angle of a plurality of actuators of the manipulator, and each rotation angle of the plurality of actuators of the manipulator is corrected by using the calculated joint offset. Hereinafter, for convenience of description, a joint offset for each rotation angle of the plurality of actuators of the manipulator will be simply referred to as a joint offset.

Through the calibration of the manipulator, the robot system 2 can cause a position of the TCP calculated on the basis of the forward kinematics to match an actual position of the TCP with high accuracy. As a result, the robot system 2 can cause the manipulator of the robot 20 to perform highly accurate work. Hereinafter, in the calibration of the manipulator, a description will be made of a process in which the robot system 2 calculates a joint offset for correcting a rotation angle of the actuator and teaches (stores) the calculated joint offset to (in) the control apparatus 30.

When the manipulator is calibrated, the robot system 2 fixes a position of the TCP to a certain position. The robot system 2 uses the jig J1 in order to fix a position of the TCP to a certain position. The robot system 2 brings a predetermined portion of an end effector provided in the robot 20 into contact with a depression H1 provided on the upper surface of the jig J1. The predetermined portion of the end effector is, for example, a tip of a protruding portion provided at a first end effector END1. A sphere is provided at the tip. A first TCP position is set in the center of the sphere. In a case where the predetermined port ion of the end effector comes into contact with the depression H1 provided on the upper surface of the jig J1, a motion of the predetermined portion of the end effector is fixed in a direction along the upper surface of the jig J1.

Hereinafter, for convenience of description, causing the predetermined portion of the end effector not to be moved in the direction along the upper surface of the jig J1 by bring the predetermined portion of the end effector into contact with the depression H1 will be referred to as fitting a predetermined portion of the first end effector END1 to the depression H1. In addition, hereinafter, for convenience of description, a position to which a position of the TCP is fixed will be referred to as a fixed position X. In this example, a description will be made of a case where the predetermined portion of the first end effector END1 is a sphere, but the predetermined portion of the first end effector END1 is not necessarily a sphere and may have other shapes as long as a position of the TCP can be fixed to the fixed position X.

In other words, the robot system 2 fits a predetermined portion of the end effector to the depression H1 in order to fix a position of the TCP to the fixed position X. The robot system 2 causes the robot 20 to perform a calibration information acquisition operation in a state in which the predetermined portion of the end effector is fitted to the depression H1.

Here, with reference to FIG. 3, a description will be made of the situation in which a position of the TCP is not changed and an attitude of the TCP is changed according to the calibration information acquisition operation.

The robot system 2 continuously presses a predetermined portion O vertically downward against the depression H1 of the upper surface of the jig J1 with a force F1 in order to maintain a state in which the predetermined portion O of the end effector is fitted to the depression H1 of the jig J1.

At this time, the robot system 2 continuously presses the predetermined portion O with a predetermined magnitude of the force F1 against the depression H1 so as not to destroy the jig J1 under the control based on force sensor information acquired from a force sensor 23 which will be described later. In the above-described way, a position of the TCP is fixed to the fixed position X and thus cannot be moved (fixed) in the direction along the upper surface of the jig J1. Therefore, in a case where the end effector is moved, for example, in a direction of an arrow F2 due to the calibration information acquisition operation while maintaining this state, an attitude of the predetermined portion O (that is, an attitude of the TCP) is changed, but a position of the predetermined portion O (that is, a position of the TCP) is not changed.

The robot system 2 causes the robot 20 to perform the calibration information acquisition operation in a state in which the predetermined portion of the end effector is fitted to the depression H1, and thus acquires information indicating a rotation angle from an encoder corresponding to each of the plurality of actuators of the robot 20 whenever an attitude of the robot 20 is changed. The robot system 2 correlates the acquired information indicating a plurality of rotation angles and information indicating an attitude of the robot 20 at this time and stores the correlated information as calibration information. The predetermined portion of the end effector may be a portion which can match a position of the TCP, and may be other portions such as predetermined portions of the manipulator.

The robot system 2 derives an equation for calculating a position of the TCP for each attitude of the robot 20 by using the forward kinematics on the basis of all pieces of calibration information acquired through the above-described processes. The derived equation is an equation which has a rotation angle of each of the actuators acquired from the encoders as an input parameter and has coordinates (three coordinate values) indicating a position of the TCP and a joint offset as the unknowns. A position of the TCP is represented by a robot coordinate system of the manipulator.

The robot system 2 solves simultaneous equations formed of the derived equations so as to calculate coordinates indicating position of the TCP as the unknown and the joint offset as the unknown. The robot system 2 calibrates the manipulator on the basis of the calculated joint offset. Through the calibration, the robot system. 2 can cause the robot 20 to perform highly accurate work on the manipulator.

The plurality of actuators may be respectively provided in joints of the first manipulator MNP1, joints of the second manipulator MNP2, and a waist portion C of the robot 20 illustrated in FIG. 10. The waist portion C may be other portions as long as all portions including the first manipulator MNP1 and the second manipulator MNP2 of the robot 20 can be rotated by using the actuators at positions thereof. Hereinafter, for convenience of description, an actuator provided in the waist portion C of the robot 20 will be referred to as a waist pivot of the robot 20. The waist portion C is an example of a main body, and the waist pivot is an example of a pivot of the main body.

Here, with reference to FIG. 4, a description will be made of each joint of the first manipulator MNP1, the second manipulator MNP2 provided in the robot 20, and the waist pivot of the robot 20.

As illustrated in FIG. 4, the waist portion C includes the waist pivot indicated by the reference sign J0, that is, an actuator. The waist pivot J0, joints J01 to J07, and the joints J11 to J17 are respectively rotated along arrows illustrated in FIG. 4. Information indicating a rotation angle of the rotation is output from an encoder related to each actuator. As illustrated in FIG. 4, the first fixed imaging unit 21 and the second fixed imaging unit 22 are provided over the waist portion C so as to be moved along with the waist pivot J0.

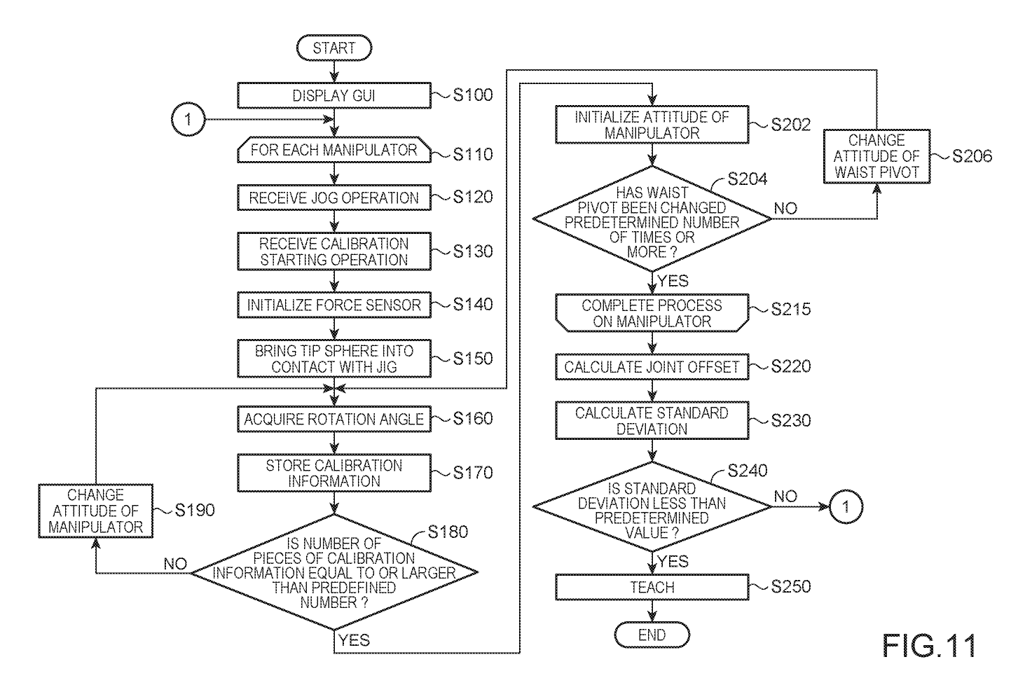

Hereinafter, with reference to FIG. 11, a description will be made of processes until the control apparatus 30 completes calibration of the first manipulator MNP1 and the second manipulator MNP2.

FIG. 11 is a flowchart illustrating an example of a flow of processes until the control apparatus 30 completes calibration of the first manipulator MNP1 and the second manipulator MNP2.

First, the display control section 40 displays a GUI assisting an operation performed by a user on the display unit 35 in the manipulator calibration process (step S100).

Next, the control unit 36 repeatedly performs processes in steps S120 to S206 on each manipulator (that is, the first manipulator MNP1 and the second manipulator MNP2) of the robot 20 (step S110). Hereinafter, for convenience of description, the description will be made of a case where the processes in steps S120 to S206 are initially performed on the first manipulator MNP1, and then the processes in steps S120 to S206 are performed on the second manipulator MNP2.

For this reason, the processes in steps S120 to S206 will be described focusing on processes on the first manipulator MNP1. The control unit 36 may be configured to initially perform the processes in steps S120 to S206 on the second manipulator MNP2 and then perform the processes in steps S120 to S206 on the first manipulator MNP1.

The robot control portion 42 fits the tip sphere TCP1 of the first end effector END1 to the depression H1 of the jig J1 on the basis of a user's jog operation received from the input reception unit 33 via the GUI displayed on the display unit 35 in step S100 (step S120). Next, the calibration control section 41 receives an operation for starting a calibration process on the first manipulator MNP1 (for example, clicking a button for starting the calibration process on the first manipulator MNP1) from the input reception unit 33 via the GUI displayed on the display unit 35 in step S100 (step S130).

Next, the robot control portion 42 moves the tip sphere TCP1 fitted to the depression H1 of the jig J1 in a predetermined direction from the depression H1 of the jig J1 by a predetermined distance. The force sensor initialization portion 43 initializes the first force sensor 23-1 at this time (step S140). The predetermined direction is a vertically upward direction but may be other directions. The predetermined distance may be a distance by which the tip sphere TCP1 is separated from the depression H1, but is preferably a distance which does not cause a deviation in a position of the tip sphere TCP1 in a direction along the upper surface of the jig J1 provided with the depression H1 due to vibration while the tip sphere TCP1 is being separated from the depression H1 of the jig J1 (alternatively, even if the deviation occurs, the tip sphere TCP1 can be easily returned to a position before being deviated by causing the tip sphere TCP1 to be located along an inner wall of the depression H1 according to control based on force sensor information, such as compliance control).

The robot control portion 42 moves the tip sphere TCP1 fitted to the depression H1 of the jig J1 in the predetermined direction from the depression H1 of the jig J1 by the predetermined distance, and then waits for vibration of the tip sphere TCP1 (or the first manipulator MNP1) to be reduced. More specifically, in this waiting, the robot control portion 42 waits for a predetermined period of time to elapse and then proceeds to the process in step S150. Alternatively, the number of vibration per unit time of the first manipulator MNP1 may be measured by the first force sensor 23-1, and the robot control portion 42 may wait for the measured number of vibration to be equal to or less than a threshold value.

Next, the robot control portion 42 moves the tip sphere TCP1 in an opposite direction to the predetermined direction in step S140 in order to fit the tip sphere TCP1 to the depression H1 of the jig J1 again. At this time, the robot control portion 42 acquires force sensor information from the force sensor information acquisition portion 44, and moves the tip sphere TCP1 until the tip sphere TCP1 is fitted to the depression H1 of the jig J1 according to control based on the force sensor information (step S150). After a position of the tip sphere TCP1 is fitted to the depression H1 of the jig J1, the robot control portion 42 applies a predetermined magnitude of force to the tip sphere TCP1 fitted to the depression H1 vertically downward. The robot control portion 42 performs processes in steps S160 to S204 while maintaining the state in which the predetermined magnitude of force is applied to the tip sphere TCP1 fitted to the depression H1 in the opposite direction to the predetermined direction in step S140.

Next, the rotation angle acquisition portion 45 acquires information indicating a rotation angle from an encoder related to each of the plurality of actuators of the waist portion C and the first manipulator MNP1 of the robot 20 (step S160). Next, the rotation angle acquisition portion stores calibration information in which information indicating a current attitude of the robot 20 is correlated with the information indicating the rotation angle acquired in step S160 in the storage unit 32 (step S170). Next, the calibration control section 41 determines whether or not the number of pieces of calibration information stored in the storage unit 32 is equal to or larger than a predefined number (step S180).

Here, the predefined number may be equal to or larger than the number of unknowns used to calculate a joint offset in the joint offset calculation portion 46, and is assumed to be 10 in this example. The calibration information is preferably acquired so that the plurality of actuators of the first manipulator MNP1 are moved at predetermined angles or more due to a changed attitude in step S190.

If the calibration control section 41 determines that the number of pieces of calibration information stored in the storage unit 32 is not equal to or larger than the predefined number (NO in step S180), the robot control portion 42 changes an attitude of the first manipulator MNP1 to the next attitude (step S190), and then performs processes in steps S160 to S180 in the changed attitude of the first manipulator MNP1.

Here, when changing an attitude of the first manipulator MNP1 to the next attitude, the robot control portion 42 may read the information indicating the attitude of the first manipulator MNP1 in order and may change the attitude of the first manipulator MNP1 in the reading order, and may change the attitude of the first manipulator MNP1 at random.

Hereinafter, a description will be made of a case where the robot control portion 42 reads the information stored in the storage unit 32 in order and changes the attitude of the first manipulator MNP1 in the reading order. Each of an attitude of the first manipulator MNP1 or an attitude of the second manipulator MNP2 is an example of an attitude of the arm.

On the other hand, the calibration control section determines that the number of pieces of calibration information stored in the storage unit 32 is equal to or larger than the predefined number (YES in step S180), the robot control portion 42 changes the attitude of the first manipulator MNP1 to the attitude of the first manipulator MNP1 at the time when the tip sphere TCP1 is fitted to the depression H1 of the jig J1 in step S150 (step S202). In FIG. 11, this control is referred to as initialization of an attitude of the manipulator.

Here, with reference to FIGS. 9A to 9C, a description will be made of a process in which the robot control portion 42 changes an attitude of the first manipulator MNP1 in step S190.

While maintaining a state in which the tip sphere TCP1 is fitted to the depression H1 of the jig J1, the robot control portion 42 changes an attitude of the first manipulator MNP1 from the attitude of the first manipulator MNP1 illustrated in FIG. 9A to the attitude of the first manipulator MNP1 illustrated in FIG. 9B or 9C. Since the attitude is changed in the above-described way, it is possible to acquire a plurality of rotation angles which are different from each other for each attitude of the first manipulator MNP1 and each rotation angle of the plurality of actuators of the first manipulator MNP1 without changing a position of the TCP of the first manipulator MNP1 which is set to the center of the tip sphere TCP1 from the fixed position X.

Next, the robot control portion 42 determines whether or not the waist pivot of the robot 20 has been changed a predetermined number of times or more (step S204). If it is determined that the waist pivot of the robot 20 has not been changed the predetermined number of times or more (NO in step S204), the robot control portion 42 controls the robot 20 to change an attitude of the waist pivot to the next attitude (step S206), and performs the processes in steps S160 to S204 in the changed attitude of the waist pivot.

On the other hand, if the robot control portion 42 determines that the waist pivot of the robot 20 has been changed the predetermined number of times or more (YES in step S204), the robot control portion 42 returns to step S100 and performs the processes in steps S120 to S206 on the second manipulator MNP2 again (step S215). The processes in steps S160 to S206 are examples of processes in which the above-described calibration information acquisition operation is performed by each of the first manipulator MNP1 and the second manipulator MNP2.

After the processes in steps S160 to S206 on the second manipulator MNP2 are completed, the joint offset calculation portion 46 reads all of the pieces of calibration information stored in the storage unit 32. The joint offset calculation portion 46 calculates joint offsets related to the plurality of actuators of each of the first manipulator MNP1 and the second manipulator MNP2 on the basis of the read calibration information, and stores information indicating the calculated joint offsets in the storage unit 32 (step S220).

Storing of the information indicating the joint offsets in the storage unit 32 in step S220 is temporary storing for using the joint offsets in a process in step S230 and is different from the above-described teaching of a joint offset.

Here, a description will be made of a process of calculating the joint offset in the joint offset calculation portion 46.

In the forward kinematics, an equation for calculating a position of the TCP of the first manipulator MNP1 is obtained for each piece of calibration information related to the first manipulator MNP1 (that is, for each combination of an attitude of the waist pivot of the robot 20 and an attitude of the first manipulator MNP1). Input parameters of the equation for calculating a position of the TCP of the first manipulator MNP1 are a rotation angle of the actuator of the waist pivot and rotation angles of the plurality of actuators of the first manipulator MNP1. The unknowns of the equation for calculating a position of the TCP of the first manipulator MNP1 are joint offsets (seven joint offsets) for correcting the respective rotation angles of the plurality of actuators of the first manipulator MNP1, and coordinates (three coordinate values) indicating a position of the TCP of the first manipulator MNP1. The joint offset calculation portion 46 is not required to calculate all the unknowns from the equation for calculating a position of the TCP of the first manipulator MNP1. For example, in a case of outputting mechanical accuracy regarding a position of the TCP of the first manipulator MNP1, it is not necessary to calculate the position of the TCP of the first manipulator MNP1.

In the forward kinematics, an equation for calculating a position of the TCP of the second manipulator MNP2 is obtained for each piece of calibration information related to the second manipulator MNP2 (that is, for each combination of an attitude of the waist pivot of the robot 20 and an attitude of the second manipulator MNP2). Input parameters of the equation for calculating a position of the TCP of the second manipulator MNP2 are a rotation angle of the actuator of the waist pivot and rotation angles of the plurality of actuators of the second manipulator MNP2. The unknowns of the equation for calculating a position of the TCP of the second manipulator MNP2 are joint offsets (seven joint offsets) for correcting the respective rotation angles of the plurality of actuators of the second manipulator MNP2, and coordinates (three coordinate values) indicating a position of the TCP of the second manipulator MNP2. The joint offset calculation portion 46 is not required to calculate all the unknowns from the equation for calculating a position of the TCP of the second manipulator MNP2. For example, in a case of outputting mechanical accuracy regarding a position of the TCP of the second manipulator MNP2, it is not necessary to calculate the position of the TCP of the second manipulator MNP2.

Here, in the robot system 2, the coordinates indicating a position of the TCP of the first manipulator MNP1 included in each equation for calculating a position of the TCP of the first manipulator MNP1 and the coordinates indicating a position of the TCP of the second manipulator MNP2 included in each equation for calculating a position of the TCP of the second manipulator MNP2 are necessarily common values since the position of the TCP of the first manipulator MNP1 and the position of the TCP of the second manipulator MNP2 are fixed to the fixed position X during the calibration information acquisition operation. By using this fact, the joint offset calculation portion 46 collectively solves simultaneous equations formed of the equations for calculating a position of the TCP of the first manipulator MNP1 and the equations for calculating the position of the TCP of the second manipulator MNP2 according to nonlinear optimization computation such as a steepest descent method, a Newton method, or a Levenberg-Marquardt method.

As a result, the joint offset calculation portion 46 calculates a joint offset for correcting each rotation angle of the plurality of actuators of the first manipulator MNP1 and a joint offset for correcting each rotation angle of the plurality of actuators of the second manipulator MNP2. During the calculation, the joint offset calculation portion 46 calculates the position of the TCP of the first manipulator MNP1 and the position of the TCP of the second manipulator MNP2 as positions represented in a certain coordinate system. Hereinafter, this coordinate system will be referred to as a shared robot coordinate system.

The robot system 2 can improve accuracy of cooperative work of the first manipulator MNP1 and the second manipulator MNP2 by using the calculated joint offsets. The cooperative work is work performed by both of the first manipulator MNP1 and the second manipulator MNP2 after a position of the TCP of the first manipulator MNP1 and a position of the TCP of the second manipulator MNP2 are moved to the same position.

In the method of calculating joint offsets by solving the simultaneous equations formed of a plurality of equations which are derived on the basis of the calibration information which is obtained by fixing a position of the TCP of the manipulator to the fixed position X, a joint offset for correcting a rotation angle of an actuator at the base (an end on an opposite side to the side on which the end effector is provided) of the manipulator is attempted to be calculated but is undefined in terms of mathematics related to the forward kinematics.

However, in the robot system 2, an actuator corresponding to the actuator of the base of the manipulator is the actuator of the waist pivot of the robot 20. For this reason, the robot system 2 can calculate all joint offsets for correcting respective rotation angles of the plurality of actuators of the first manipulator MNP1 and the second manipulator MNP2.

The robot system 2 calibrates the first manipulator MNP1 and the second manipulator MNP2 by using the calculated first joint offset and second joint offset and also fixing the waist pivot to a certain position, and can thus improve accuracy of cooperative work of the first manipulator MNP1 and the second manipulator MNP2. The robot system 2 calibrates the first manipulator MNP1 and the second manipulator MNP2 by using the calculated first joint offset and second joint offset and also fixing the waist pivot to a certain position, and can thus improve accuracy of work performed by each of the first manipulator MNP1 and the second manipulator MNP2. The robot system 2 may be configured to calculate a joint offset of the actuator of the waist pivot by using other devices and calibrate the actuator of the waist pivot on the basis of the calculated joint offset.

Next, the error evaluation portion 47 reads the information indicating the joint offsets related to the first manipulator MNP1, stored in the storage unit 32 in step S220, from the storage unit 32. The error evaluation portion 47 reads all of the pieces of calibration information related to the first manipulator MNP1 stored in step S170 from the storage unit 32 one by one. The error evaluation portion 47 calculates a position of the TCP of the first manipulator MNP1 according to the forward kinematics based on the rotation angles included in the calibration information and the read joint offsets for each piece of read calibration information. The error evaluation portion 47 calculates a standard deviation of the positions of the TCP of the first manipulator MNP1 as a first standard deviation on the basis of all the positions of the TCP of the first manipulator MNP1 calculated for each piece of the calibration information (that is, for each attitude of the robot 20).

Next, the error evaluation portion 47 reads the information indicating the joint offsets related to the second manipulator MNP2, stored in the storage unit 32 in step S220, from the storage unit 32. The error evaluation portion 47 reads all of the pieces of calibration information related to the second manipulator MNP2 calculated in step S170 from the storage unit 32 one by one. The error evaluation portion 47 calculates a position of the TCP of the second manipulator MNP2 according to the forward kinematics based on the rotation angles included in the calibration information and the read joint offsets for each piece of read calibration information. The error evaluation portion 47 calculates a standard deviation of the positions of the TCP of the second manipulator MNP2 as a second standard deviation on the basis of all the positions of the TCP of the second manipulator MNP2 calculated for each piece of the calibration information (that is, for each attitude of the robot 20) (step S230).

Next, the error evaluation portion 47 determines (evaluates) whether or not both of the first standard deviation and the second standard deviation are less than a predetermined value Y1 (step S240). If it is determined that one of the first standard deviation calculated in step S230 and the second standard deviation calculated in step S230 is not less than the predetermined value Y1 (NO in step S240), the robot control portion 42 returns to step S110 and acquires calibration information related to the first manipulator MNP1 and the second manipulator MNP2 again so as to calculate joint offsets again.

On the other hand, if the error evaluation portion 47 determines that the first standard deviation calculated in step S230 and the second standard deviation calculated in step S230 are less than the predetermined value Y1 (YES in step S240), the teaching portion 48 stores the joint offsets calculated in step S220 in the storage unit 32 (step S250). Storing of information indicating the first joint offset and information indicating the second joint offset in the storage unit 32 in step S250 indicates the above-described teaching of the first joint offset and the second joint offset.

In the present embodiment, the teaching portion 48 is configured to determine whether or not both of the first standard deviation calculated in step S230 and the second standard deviation calculated in step S230 are less than the predetermined value Y1, but, alternatively, if the error evaluation portion 47 determines that one of the first standard deviation calculated in step S230 and the second standard deviation calculated in step S230 is less than the predetermined value Y1, the joint offsets calculated in step S220 may be stored (taught) in (to) the storage unit 32.

The robot control portion 42 acquires the information indicating a rotation angle of each actuator by changing an attitude of the first manipulator MNP1 while maintaining a state in which the tip sphere TCP1 is fitted to the depression H1 of the jig J1, that is, comes into contact with the depression H of the jig J in the processes in steps S150 to S204, but, alternatively, may acquire the information indicating a rotation angle of each actuator by changing an attitude of the first manipulator MNP1 while maintaining a state in which the depression H1 and the tip sphere TCP1 are separated from each other by a predetermined distance. In this case, the robot control portion 42 changes an attitude of the first manipulator MNP1 so that a relative positional relationship between the tip sphere TCP1 and the depression H1 is not changed (that is, the relative positional relationship is fixed). A distance between the tip sphere TCP1 and the depression H1 when a relative positional relationship between the tip sphere TCP1 and the depression H1 is fixed is a distance between, for example, the deepest portion (the center of the depression H1 in this example) of the depression H1 and a point where the tip sphere TCP1 is in contact with the depression H1, but may be a distance between other two points.

The robot control portion 42 acquires the information indicating a rotation angle of each actuator by changing an attitude of the second manipulator MNP2 while maintaining a state in which the tip sphere TCP2 is fitted to the depression H1 of the jig J1, that is, comes into contact with the depression H of the jig J1 in the processes in steps S150 to S204, but, alternatively, may acquire the information indicating a rotation angle of each actuator by changing an attitude of the second manipulator MNP2 while maintaining a state in which the depression H1 and the tip sphere TCP2 are separated from each other by a predetermined distance. In this case, the robot control portion 42 changes an attitude of the second manipulator MNP2 so that a relative positional relationship between the tip sphere TCP2 and the depression H1 is not changed (that is, the relative positional relationship is fixed).

A distance between the tip sphere TCP2 and the depression H1 when a relative positional relationship between the tip sphere TCP2 and the depression H1 is fixed is a distance between, for example, the deepest portion (the center of the depression H1 in this example) of the depression H1 and a point where the tip sphere TCP1 is in contact with the depression H1, but may be a distance between other two points. A distance between the tip sphere TCP1 (or the tip sphere TCP2) and the depression H1 when a relative positional relationship between the tip sphere TCP1 (or the tip sphere TCP2) and the depression H1 is fixed is an example of a distance of 1.

As described above, in the present embodiment, the robot system 2 calibrates the first manipulator MNP1 (or the second manipulator MNP2) by causing the first manipulator MNP1 (or the second manipulator MNP2) to take a plurality of attitudes on the basis of force sensor information acquired from at least the force sensor 23 after the tip sphere TCP1 (or the tip sphere TCP2) is moved so that a distance between the tip sphere TCP1 (or the tip sphere TCP2) and the jig J1 becomes the distance of 1. Consequently, the robot system 2 can easily calibrate the manipulator.

The robot system 2 calibrates the first manipulator MNP1 (or the second manipulator MNP2) by causing the first manipulator MNP1 (or the second manipulator MNP2) to take a plurality of attitudes on the basis of force sensor information acquired from at least the force sensor 23 after the tip sphere TCP1 (or the tip sphere TCP2) is moved so that a distance between the tip sphere TCP1 (or the tip sphere TCP2) and the jig J1 becomes a distance of substantially 0. Consequently, the robot system 2 can calibrate the first manipulator MNP1 (second manipulator MNP2) by causing the first manipulator MNP1 (second manipulator MNP2) to take one or more attitudes while maintaining a state in which the tip sphere TCP1 (tip sphere TCP2) is in contact with the jig J1.

The robot system 2 moves the tip sphere TCP1 (tip sphere TCP2) so that a distance between the tip sphere TCP1 (tip sphere TCP2) and the jig J1 becomes the distance of 1, then initializes the force sensor 23 by moving tip sphere TCP1 (tip sphere TCP2) so that a distance between the tip sphere TCP1 (tip sphere TCP2) and the jig J1 becomes a distance which is different from the distance of 1, and then also moves the tip sphere TCP1 (tip sphere TCP2) again so that a distance between the tip sphere TCP1 (tip sphere TCP2) and the jig J1 becomes the distance of 1. Consequently, the robot system 2 can minimize errors caused by an external force such as gravity applied to the force sensor 23.

When the force sensor 23 is initialized, the robot system 2 waits for vibration of the first end effector END1 (or the second end effector END2) to be reduced, then initializes the force sensor 23, and moves the tip sphere TCP1 (tip sphere TCP2) so that a distance between the tip sphere TCP1 (tip sphere TCP2) and the jig J1 becomes the distance of 1. Consequently, the robot system 2 can minimize errors in the initialization of the force sensor 23, caused by vibration of the tip sphere TCP1 (or the tip sphere TCP2).

The robot system 2 causes the first manipulator MNP1 (or the second manipulator MNP2) to take a plurality of attitudes in a state in which the tip sphere TCP1 (or the tip sphere TCP2) is in contact with the depression H1 of the jig J1. Consequently, the robot system 2 can cause the first manipulator MNP1 (or the second manipulator MNP2) to take a plurality of attitudes in a state in which a position of the tip sphere TCP1 (or the tip sphere TCP2) is fixed, and can thus calibrate the first manipulator MNP1 (or the second manipulator MNP2).

The robot system 2 collectively calibrates the first manipulator MNP1 and the second manipulator MNP2. Consequently, the robot system 2 can improve accuracy of cooperative work between the first manipulator MNP1 and the second manipulator MNP2.

### Third Embodiment

Hereinafter, a third embodiment will be described with reference to the drawings.

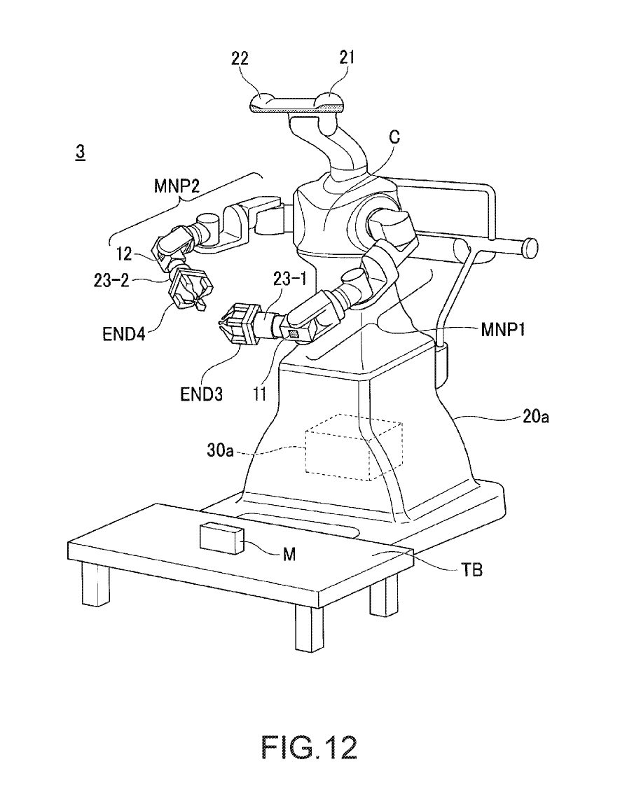

FIG. 12 is a configuration diagram illustrating an example of a robot system 3 according to the present embodiment.

The robot system 3 according to the third embodiment includes a robot 20a and a control apparatus 30a. In the third embodiment, the same constituent elements as in the second embodiment are given the same reference numerals, and description thereof will be omitted.

The robot system 3 calibrates the first manipulator MNP1 and the second manipulator MNP2 according to the method described in the second embodiment, and then causes to the robot 20a to dispose a work target M disposed on the upper surface of the work table TB at a predetermined position again. Hereinafter, this work will be referred to as predetermined work. When the predetermined work is performed, in the robot system 3, a rotation angle of the waist pivot of the robot 20a is fixed to a certain rotation angle, and the robot 20a is caused to perform the predetermined work by using either or both of the first manipulator MNP1 and the second manipulator MNP2.

The robot 20a illustrated in FIG. 12 is in a state in which calibration of each of the first manipulator MNP1 and the second manipulator MNP2 has been performed on the robot 20 of the second embodiment according to the method described in the second embodiment. Instead of the first end effector END1 and the second end effector END2 provided in the robot 20, the robot 20a is provided with a third end effector END3 and a fourth end effector END4 each including a claw portion which can grip the work target M. Hereinafter, a description will be made assuming that the robot 20a calibrates the first manipulator MNP1 and the second manipulator MNP2 and replaces the first end effector END1 and the second end effector END2 with the third end effector END3 and the fourth end effector END4.

The work target M is an object having a size and a shape which can be gripped by either or both of the third end effector END3 and the fourth end effector END4, and is, for example, apart (a screw or a bolt) used in an industrial machine. In FIG. 12, the work target M is illustrated as a rectangular parallelepiped object, but may be objects having other shapes or sizes.

The first fixed imaging unit 21 and the second fixed imaging unit 22 capture images of an imaging region is a stereoscopic manner. Hereinafter, images captured by the first fixed imaging unit 21 and the second fixed imaging unit in a stereoscopic manner will be referred to as stereoscopically captured images. Here, the imaging region indicates a region which can be captured in a stereoscopic manner by the first fixed imaging unit 21 and the second fixed imaging unit 22 when a rotation angle of the waist pivot is fixed to a certain rotation angle. The work target M and the predetermined position where the work target M is disposed are assumed to be included in the region which can be imaged by the first fixed imaging unit 21 and the second fixed imaging unit 22 in a stereoscopic manner. The stereoscopic captured image is a still image, but, alternatively, may be a moving image.

A position on the stereoscopic captured image and a position in a camera coordinate system are assumed to be correlated with each other in advance through any calibration. A position in a world coordinate system and a position in the camera coordinate system are assumed to be correlated with each other in advance through any calibration.

Each of the functional units (the first moving imaging unit 11, the second moving imaging unit 12, the first fixed imaging unit 21, the second fixed imaging unit 22, the first force sensor 23-1, the second force sensor 23-2, the third end effector END3, the fourth end effector END4, the first manipulator MNP1, the second manipulator MNP2, and a plurality of actuators (not illustrated)) provided in the robot 20a is controlled on the basis of a control signal which is input from the control apparatus 30a. The robot 20a causes either or both of the third end effector END3 and the fourth end effector END4 to grip the work target M and to move the gripped work target M to a predetermined position and to dispose the work target M at the position.

The control apparatus 30a calibrates each of the first manipulator MNP1 and the second manipulator MNP2 according to the method described in the second embodiment. After the first end effector END1 and the second end effector END2 of the robot 20a are replaced with the third end effector END3 and the fourth end effector END4 by a user, the control apparatus 30a causes the first fixed imaging unit 21 and the second fixed imaging unit 22 to stereoscopically image the range which can be imaged by the first fixed imaging unit 21 and the second fixed imaging unit 22, and detects the work target M through pattern matching or the like on the basis of stereoscopically captured images which have been captured. In a case where the work target M is detected from the stereoscopically captured images, the control apparatus 30a calculates a position and an attitude of the work target M in the camera coordinate system on the basis of the stereoscopically captured images.

The control apparatus 30a transforms the position and the attitude of the work target M in the camera coordinate system into a position and an attitude in the above-described shared robot coordinate system. The control apparatus 30a causes either or both of the third end effector END3 and the fourth end effector END4 to grip the work target M on the basis of the position and the attitude of the work target M in the shared robot coordinate system obtained through the transform, and to dispose the gripped work target M at a predetermined position. The position in the camera coordinate system and the position in the shared robot coordinate system are assumed to be correlated with each other in advance through any calibration.

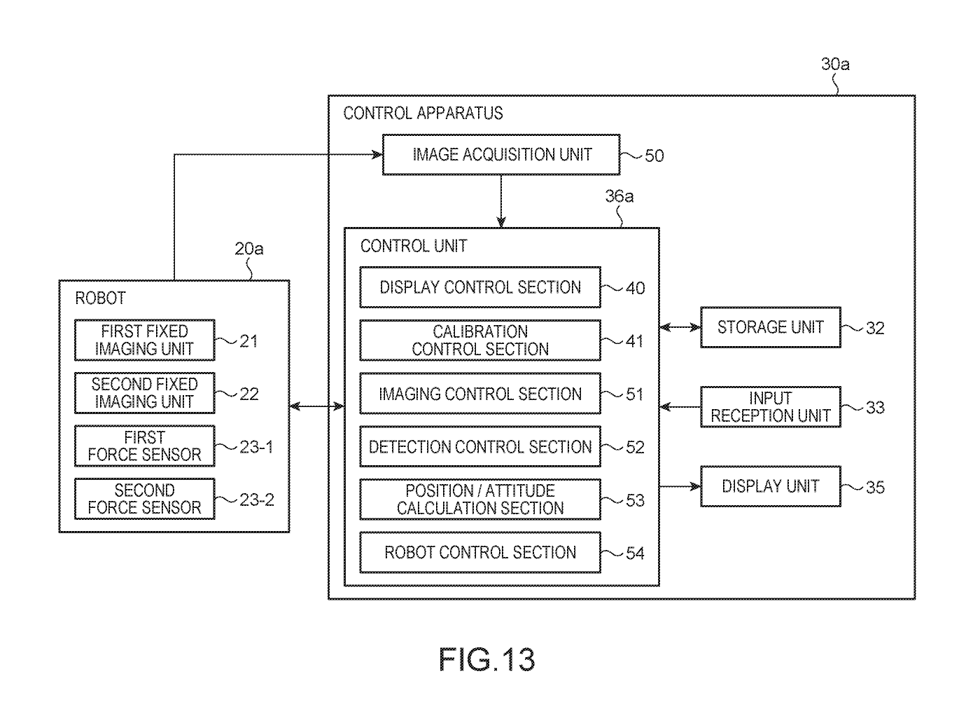

Next, with reference to FIG. 13, a functional configuration of the control apparatus 30a will be described.

FIG. 13 is a diagram illustrating an example of a functional configuration of the control apparatus 30a.

The control apparatus 30a includes the storage unit 32, the input reception unit 33, the display unit 35, a control unit 36a, and an image acquisition unit 50. Some or all functional portions of the control unit 36a are realized by, for example, the CPU 31 executing various programs stored in the storage unit 32. Some or all of the functional portions may be hardware functional portions such as large scale integration (LSI) or an application specific integrated circuit (ASIC).

The image acquisition unit 50 acquires stereoscopically captured images which have been captured in a stereoscopic manner by the first fixed imaging unit 21 and the second fixed imaging unit 22. The image acquisition unit 50 outputs the acquired stereoscopically captured images to the control unit 36a.

The control unit 36a controls the entire control apparatus 30. The control unit 36 includes a display control section 40, a calibration control section 41, an imaging control section 51, a detection control section 52, a position/attitude calculation section 53, and a robot control section 54.

The imaging control section 51 controls the first fixed imaging unit 21 and the second fixed imaging unit 22 to stereoscopically image the range which can be imaged thereby.

The detection control section 52 detects the work target M through pattern matching or the like from the stereoscopically captured images on the basis of the stereoscopically captured images acquired from the image acquisition unit 50.

The position/attitude calculation section 53 calculates a position and an attitude in the shared robot coordinate system of the work target M which has been detected from the stereoscopically captured images by the detection control section 52.

The robot control section 54 causes the robot 20a to perform predetermined work on the basis of the position and the attitude of the work target Min the shared robot coordinate system calculated by the position/attitude calculation section 53.

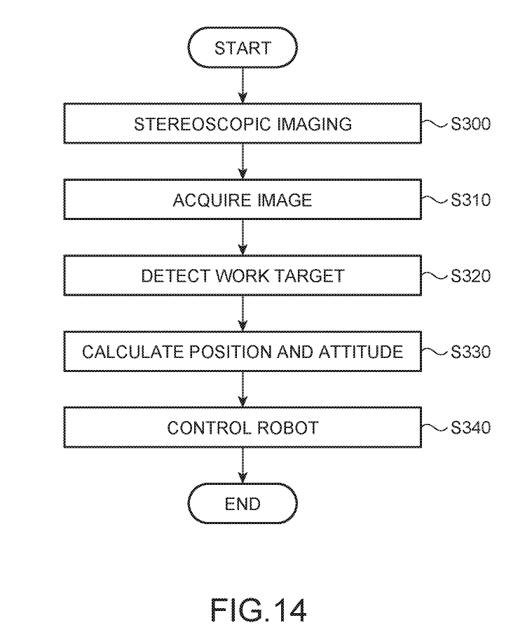

Hereinafter, with reference to FIG. 14, a description will be made of a process in which the control apparatus 30a causes the robot 20a to perform predetermined work.

FIG. 14 is a flowchart illustrating an example of a flow of the process in which the control apparatus 30a causes the robot 20a to perform predetermined work.

First, the imaging control section 51 causes the first fixed imaging unit 21 and the second fixed imaging unit 22 to stereoscopically capture images of an imaging region (step S300). Next, the image acquisition unit 50 acquires stereoscopically captured images which have been stereoscopically captured by the first fixed imaging unit 21 and the second fixed imaging unit 22, and outputs the acquired stereoscopically captured images to the control unit 36a (step S310).

Next, the detection control section 52 detects the work target M from the stereoscopically captured images acquired from the image acquisition unit 50 in step S310 (step S320). Next, the position/attitude calculation section 53 calculates a position and an attitude in the robot coordinate system of the work target M detected in step S320 on the basis of the stereoscopically captured images acquired by the image acquisition unit 50 in step S310 (step S330). Next, the robot control section 54 causes the robot 20a to perform predetermined work on the basis of the position and the attitude of the work target Min the robot coordinate system calculated in step S330 (step S340).

As described above, the robot system 3 according to the third embodiment can perform the predetermined work with high accuracy through the calibration of the manipulator described in the second embodiment.

### Fourth Embodiment

Hereinafter, a fourth embodiment will be described with reference to the drawings. In the fourth embodiment, the same constituent elements as in the second embodiment are given the same reference numerals, and description thereof will be omitted.

The robot calibration system (robot system) 2 includes a robot 20 provided with a plurality of manipulators, and a control apparatus 30. The robot calibration system 2 calibrates the manipulators of the robot 20 by using the jig J1 illustrated in FIG. 10. The robot calibration system 2 repeatedly performs some calibration processes performed on a certain manipulator, on other one or more manipulators.

Therefore, first, a description will be made of a case where a single manipulator is provided in the robot 20. Hereinafter, for convenience of description, a single manipulator provided in the robot 20 will be referred to as a first manipulator MNP1.

The robot calibration system 2 acquires information indicating a rotation angle of each of a plurality of actuators provided in the first manipulator MNP1, from an encoder connected to (or included in) each actuator. Hereinafter, for convenience of description, the rotation angle of the actuator will be simply referred to as a rotation angle in some cases.

In the robot calibration system 2, the control apparatus 30 calculates a current position of a TCP of the first manipulator MNP1 by using the rotation angle acquired from each encoder on the basis of the forward kinematics. Hereinafter, for convenience of description, the TCP of the first manipulator MNP1 will be referred to as a first TCP, and a position of the first TCP will be referred to as a first TCP position. The robot calibration system 2 controls the robot 20 to perform various pieces of work by using the first manipulator MNP1 on the basis of the calculated first TCP position.

However, the calculated first TCP position may indicate a position which is different from an actual first TCP position due to errors caused by elasticity of a member constituting the first manipulator MNP1 or errors related to rotation of the actuator. Calibration of the first manipulator MNP1 performed by the robot calibration system 2 indicates correction of a difference between the calculated first TCP position and the actual first TCP position.

Hereinafter, the value η for correcting a rotation angle of the actuator as shown in Equation (1) will be referred to as a joint offset. Therefore, the calibration of the first manipulator MNP1 performed by the robot calibration system 2 indicates that a joint offset is calculated for each rotation angle of a plurality of actuators of the first manipulator MNP1, and each rotation angle of the plurality of actuators of the first manipulator MNP1 is corrected by using the calculated joint offset. Hereinafter, for convenience of description, a joint offset for each rotation angle of the plurality of actuators of the first manipulator MNP1 will be collectively referred to as a first joint offset.

Through the calibration of the first manipulator MNP1, the robot system 2 can cause a first TCP position calculated on the basis of the forward kinematics to match an actual first TCP position with high accuracy. As a result, the robot calibration system 2 can cause the first manipulator MNP1 of the robot 20 to perform highly accurate work. Hereinafter, a first TCP position simply mentioned will indicate an actual first TCP position.

When the first manipulator MNP1 is calibrated, the robot calibration system 2 fixes the first TCP position to a certain position. The robot calibration system 2 may fix the first TCP position within a predetermined region instead of a certain position, but the configuration in which the first TCP position is fixed to the certain position is preferably used since, in this configuration, errors caused by a deviation in the first TCP position within the predetermined region can be minimized.

The robot calibration system 2 uses, for example, the jig J1 in order to fix the first TCP position to the certain position. The robot calibration system 2 brings a predetermined portion of the first end effector END1 provided in the first manipulator MNP1 into contact with the depression H1 provided on the upper surface of the jig J1. The predetermined portion of the first end effector END1 is, for example, a tip of a protruding portion provided at the first end effector END1. A sphere is provided at the tip. The first TCP position is set in the center of the sphere. In a case where the predetermined portion of the first end effector END1 comes into contact with the depression H1 provided on the upper surface of the jig J1, the predetermined portion of the first end effector END1 is not moved in a direction along the upper surface of the jig J1.

Hereinafter, for convenience of description, causing the predetermined portion of the first end effector END1 not to be moved in the direction along the upper surface of the jig J1 by bring the predetermined portion of the first end effector END1 into contact with the depression H1 will be referred to as fitting the predetermined portion of the first end effector END1 to the depression H1. In addition, hereinafter, for convenience of description, a position to which the first TCP position is fixed will be referred to as a fixed position X. In this example, a description will be made of a case where the predetermined portion of the first end effector END1 is a sphere, but the predetermined portion of the first end effector END1 is not necessarily a sphere and may have other shapes as long as the first TCP position can be fixed to the fixed position X.

In other words, the robot calibration system 2 fits the predetermined portion of the first end effector END1 to the depression H1 in order to fix the first TCP position to the fixed position X. The robot calibration system 2 causes the robot 20 to perform a calibration information acquisition operation in a state in which the predetermined portion of the first end effector END1 is fitted to the depression H1.

Here, a state in which the predetermined portion of the first end effector END1 is fitted to the depression H1 indicates a state in which the first TCP position is fixed to the fixed position X, but an attitude of the first TCP is not fixed. In this example, an attitude of the first TCP of the first manipulator MNP1 is set by using a value matching an attitude of the predetermined portion of the end effector through calculation in the CPU. The attitude of the predetermined portion of the end effector is defined by directions of coordinate axes set for the predetermined port ion of the end effector. The attitude of the first TCP may be set to match attitudes of other portions.

The calibration information acquisition operation indicates an operation of changing an attitude of the robot 20 in a state in which the predetermined portion of the first end effector END1 is fitted to the depression H1 of the jig J1. The attitude of the robot 20 is designated by each rotation angle of a plurality of actuators (including the actuators of the first manipulator MNP1, and actuators of the robot 20 other than the actuators of the first manipulator MNP1 in the robot 20) of the robot 20.

The first TCP position is not changed due to the calibration information acquisition operation since the predetermined portion of the first end effector END1 is fitted to the depression H1. On the other hand, an attitude of the first TCP is changed due to the calibration information acquisition operation. As mentioned above, in order to realize a situation in which the first TCP position is not changed and an attitude of the first TCP is changed according to the calibration information acquisition operation, a shape of the predetermined portion of the first end effector END1 is preferably a spherical shape, but may be other shapes as long as the first TCP position is not changed from the fixed position X due to the calibration information acquisition operation.

Here, with reference to FIG. 3, a description will be made of the situation in which the first TCP position is not changed and an attitude of the first TCP is changed according to the calibration information acquisition operation. The robot calibration system 2 continuously presses a predetermined portion O vertically downward against the depression H1 of the upper surface of the jig J1 with a force F1 in order to maintain a state in which the predetermined portion O of the first end effector END1 is fitted to the depression H1 of the jig J1.

At this time, the robot calibration system 2 continuously presses the predetermined portion O with a predetermined magnitude of the force F1 against the depression H1 so as not to destroy the jig J1 under the control (for example, compliance control) based on force sensor information. In the above-described way, the first TCP position is fixed to the fixed position X and thus cannot be moved (fixed) in the direction along the upper surface of the jig J1. Therefore, in a case where the first end effector END1 is moved, for example, in a direction of an arrow F2 due to the calibration information acquisition operation while maintaining this state, an attitude of the predetermined portion O (that is, an attitude of the first TCP) is changed, but a position of the predetermined portion O (that is, the first TCP position) is not changed.

The robot calibration system 2 causes the robot 20 to perform the calibration information acquisition operation in a state in which the predetermined portion of the first end effector END1 is fitted to the depression H1, and thus acquires information indicating a rotation angle from an encoder corresponding to each of the plurality of actuators of the robot 20 whenever an attitude of the robot 20 is changed. The robot calibration system 2 correlates the acquired information indicating a plurality of rotation angles and information indicating an attitude of the robot 20 at this time and stores the correlated information as calibration information. The predetermined portion of the first end effector END1 may be any portion as long as the portion can match a position of the TCP.

The robot calibration system 2 derives an equation for calculating the first TCP position for each attitude of the robot 20 by using the forward kinematics on the basis of all pieces of acquired calibration information stored through the above-described processes. The derived equation is an equation which has a rotation angle of each of the actuators acquired from the encoders as an input parameter and has coordinates (three coordinate values) indicating the first TCP position and the first joint offset as the unknowns. The first TCP position is represented by a robot coordinate system of the first manipulator MNP1.

The robot calibration system 2 solves simultaneous equations formed of the derived equations so as to calculate coordinates indicating the first TCP position as the unknown and the first joint offset as the unknown. The robot calibration system 2 calibrates the first manipulator MNP1 on the basis of the calculated first joint offset. Through the calibration, the robot calibration system 2 can cause the first manipulator MNP1 to perform highly accurate work.

The above description relates to a description of the processes related to calibration of the manipulator in a case where the robot 20 is provided with a single manipulator. Next, a description will be made of calibration of a plurality of manipulators performed by the robot calibration system 2. Hereinafter, a description will be made of a case where the robot 20 includes two manipulators. In addition, hereinafter, the two manipulators included in the robot 20 will be respectively referred to as a first manipulator MNP1 and a second manipulator MNP2. Hereinafter, a TCP of the second manipulator MNP2 will be referred to as a second TCP, and a position of the second TCP will be referred to as a second TCP position.

The robot calibration system 2 causes each of the first manipulator MNP1 and the second manipulator MNP2 to the above-described calibration information acquisition operation. Hereinafter, for convenience of description, the calibration information acquisition operations performed by the first manipulator MNP1 and the second manipulator MNP2 will be referred to as a first calibration information acquisition operation and a second calibration information acquisition operation in order. Hereinafter, pieces of calibration information acquired through the first calibration information acquisition operation and the second calibration information acquisition operation will be referred to as first calibration information and second calibration information in order.

In other words, the robot calibration system 2 causes the first manipulator to perform the first calibration information acquisition operation so as to acquire the first calibration information for each attitude of the robot 20. During the first calibration information acquisition operation, the robot calibration system 2 continuously maintains a state in which a predetermined portion of the first end effector END1 of the first manipulator MNP1 is fitted to the depression H1 of the jig J1. The robot calibration system 2 stores the acquired first calibration information for each attitude of the robot. At this time, the robot calibration system 2 causes identification information (for example, an identification ID) for identifying the first manipulator MNP1 to be included in the first calibration information.

The robot calibration system 2 performs the process performed on the first manipulator MNP1, on the second manipulator MNP2 in the same manner. Consequently, the robot calibration system 2 calculates the first calibration information for each attitude of the robot 20 and the second calibration information for each attitude of the robot 20. The robot calibration system 2 stores the acquired first calibration information for each attitude of the robot 20 and the acquired second calibration information for each attitude of the robot 20.

The robot calibration system 2 derives a plurality of equations for calculating coordinates indicating the first TCP position for each attitude of the robot 20 according to the forward kinematics on the basis of the stored first calibration information. The robot calibration system 2 derives the equations for each of the first calibration information and the second calibration information. Here, as described above, the whole of the first calibration information and the second calibration information are acquired in a state in which each of the first TCP position and the second TCP position are fixed to the fixed position X.

Among the unknowns included in the equations, coordinates indicating the first TCP position and the second TCP position are necessarily common to all the equations (hereinafter, referred to as a constraint condition). Under this constraint condition, coordinates indicating the first TCP position and the second TCP position as common values are represented by a coordinate system common to both of the first manipulator MNP1 and the second manipulator MNP2. Hereinafter, the common coordinate system will be referred to as a shared robot coordinate system.

On the basis of the constraint condition, the robot calibration system 2 collectively solves simultaneous equations formed of all equations derived for each of the first calibration information and the second calibration information, so as to collectively calculate the first joint offset and a second joint offset which are the unknowns. Here, the second joint offset indicates a joint offset for each rotation angle of the plurality of actuators of the second manipulator MNP2.

By collectively solving the simultaneous equations in the above-described way, the robot calibration system 2 can make errors generated in the calculated first joint offset and second joint offset common for each manipulator. In other words, the robot calibration system 2 collectively solves the simultaneous equations and can thus reduce an individual difference between the manipulators.

If the above-described constraint condition is present when the simultaneous equations are collectively solved, the robot calibration system 2 may omit the process of calculating coordinates indicating a position of the TCP in the shared robot coordinate system. The robot calibration system 2 can complete calculation of the first joint offset and the second joint offset in a case where the process is omitted faster than in a case where the process is not omitted.

The robot calibration system 2 calibrates the first manipulator MNP1 and the second manipulator MNP2 on the basis of the calculated first joint offset and second joint offset, and thus the positions of the TCPs calculated according to the forward kinematics in the shared robot coordinate system can be made to respectively match the first TCP position and the second TCP position with high accuracy. As a result, the robot calibration system 2 can reduce minimize errors generated when work is performed by a plurality of manipulators.

In other words, the robot calibration system 2 can cause all or some manipulators of the robot 20 to perform highly accurate cooperative work on the basis of a position represented by a certain shared robot coordinate system. This is because the calculated first joint offset and second joint offset are calculated in order to correct a rotation angle of each actuator when a position of the TCP of each manipulator is made to match the position represented by the shared robot coordinate system. The cooperative work is work performed by each manipulator after a position of the TCP of the manipulator and a position of the TCP of another manipulator are moved to the same position (for example, a certain position X).

The robot calibration system 2 calibrates the first manipulator MNP1 and the second manipulator MNP2 on the basis of the calculated first joint offset and second joint offset, and can thus improve accuracy of work performed by a plurality of manipulators in a work region including the jig J1 or a work region near the jig J1.

The robot calibration system 2 calibrates the first manipulator MNP1 on the basis of the calculated first joint offset and can thus cause the first manipulator MNP1 of the robot 20 to perform highly accurate work. The robot calibration system 2 calibrates the second manipulator MNP2 on the basis of the calculated second joint offset and can thus cause the second manipulator MNP2 of the robot 20 to perform highly accurate work.

After calculating the first joint offset and the second joint offset, the robot calibration system 2 teaches (stores) the calculated first joint offset and second joint offset to (in) the control apparatus 30. Hereinafter, a description will be made of processes in which the robot calibration system 2 calculates the first joint offset and the second joint offset, and teaches (stores) the calculated first joint offset and second joint offset to (in) the control apparatus 30.

Here, a description will be made of the robot 20 and the control apparatus 30 included in the robot calibration system 2. In the present embodiment, for convenience of description, a description will be made of a case where the robot 20 includes two manipulators, but, alternatively, three or more manipulators may be provided.

The robot 20 is a double-arm robot including a first moving imaging unit 11, a second moving imaging unit 12, a first fixed imaging unit 21, a second fixed imaging unit 22, a first force sensor 23-1, a second force sensor 23-2, a first end effector END1, a second end effector END2, a first manipulator MNP1, a second manipulator MNP2, and a plurality of actuators (not illustrated). The double-arm robot indicates a robot having two arms, and, in the present embodiment, has two arms such as an arm (hereinafter, referred to as a first arm) constituted of the first end effector END1 and the first manipulator MNP1, and an arm (hereinafter, referred to as a second arm) constituted of the second end effector END2 and the second manipulator MNP2.

The robot 20 may be a three-or-more arm robot instead of the double-arm robot. The three-or-more arm robot indicates a robot having three or more arms. The robot 20 further includes the control apparatus 30 built thereinto, and is controlled by the built control apparatus 30. The robot 20 may be configured to be controlled by the control apparatus 30 which is externally installed, instead of being configured to include the built control apparatus 30.

The plurality of actuators may be respectively provided in joints of the first manipulator MNP1, joints of the second manipulator MNP2, and a waist portion C of the robot 20 illustrated in FIG. 10. The waist portion C may be other portions as long as all portions including the first manipulator MNP1 and the second manipulator MNP2 of the robot 20 can be rotated by using the actuators at positions thereof. Hereinafter, for convenience of description, an actuator provided in the waist portion C of the robot 20 will be referred to as a waist pivot of the robot 20. The waist portion C is an example of a main body, and the waist pivot is an example of a pivot of the main body.

Here, with reference to FIG. 4, a description will be made of each joint of the first manipulator MNP1, the second manipulator MNP2 provided in the robot 20, and the waist pivot of the robot 20. As illustrated in FIG. 4, the first manipulator MNP1 includes seven joints indicated by the reference signs J01 to J07, that is, seven actuators.

The second manipulator MNP2 includes seven joints indicated by the reference signs J11 to J17, that is, seven actuators. The waist portion C includes the waist pivot indicated by the reference sign J0, that is, an actuator. The waist pivot J0, joints J01 to J07, and the joints J11 to J17 are respectively rotated along arrows illustrated in FIG. 4. Information indicating a rotation angle of the rotation is output from an encoder related to each actuator. As illustrated in FIG. 4, the first fixed imaging unit 21 and the second fixed imaging unit 22 are provided over the waist portion C so as to be moved along with the waist pivot J0. Each rotation angle of the plurality of actuators of the first manipulator MNP1 is an example of a parameter for controlling the first arm. Each rotation angle of the plurality of actuators of the second manipulator MNP2 is an example of a parameter for controlling the second arm.

Here, with reference to FIG. 5, a description will be made of the first end effector END1 of the robot 20. The second end effector END2 has the same structure as that of the first end effector END1, and thus description thereof will be omitted. As illustrated in FIG. 5, the first end effector END1 is provided with a protruding portion P, and a sphere TCP1 is provided at a tip of the protruding portion P.

Hereinafter, the sphere TCP1 of the tip will be referred to as a tip sphere TCP1. The above-described predetermined portion of the end effector indicates the tip sphere. In other words, the predetermined portion of the first end effector END1 indicates the tip sphere TCP1. The tip sphere TCP1 is provided so that a central position of the tip sphere TCP1 matches a position of the TCP of the first manipulator MNP1 (or the position of the TCP of the first manipulator MNP1 matches the central position of the tip sphere TCP1). Hereinafter, for convenience of description, the central position of the tip sphere TCP1 will be referred to as a position of the tip sphere TCP1, and the central position of the tip sphere TCP2 will be referred to as a position of the tip sphere TCP2. The tip sphere TCP1 is an example of a first member of the first arm. The tip sphere TCP2 is an example of a first member of the second arm.

The protruding portion P is provided at the first end effector END1 so that a central axis CL2 extending in a longitudinal direction of the protruding portion is separated from a central axis CL1 passing through the center of a flange of the first manipulator MNP1 by an offset OF. Hereinafter, a structure in which the central axis CL2 of the tip sphere TCP1 is separated from the central axis CL1 of the first manipulator MNP1 by the offset OF will be referred to as an offset structure.

In the present embodiment, the first end effector END1 is a dedicated end effector for calibrating the first manipulator MNP1, but, alternatively, may be other end effector provided with predetermined portions having the offset structure. The central axis CL1 is a rotation axis of the joint J07 illustrated in FIG. 4 and is an example of a rotation axis of the tip of the first arm. The central axis CL1 in the second end effector END2 is a rotation axis of the joint J17 illustrated in FIG. 4 and is an example of a rotation axis of the tip of the second arm.

Next, with reference to FIG. 7, a functional configuration of the control apparatus 30 will be described.

The joint offset calculation portion 46 acquires the first calibration information stored in the storage unit 32. The joint offset calculation portion 46 calculates the first joint offset on the basis of the acquired first calibration information. The joint offset calculation portion 46 acquires the second calibration information stored in the storage unit 32. The joint offset calculation portion 46 calculates the second joint offset on the basis of the acquired second calibration information. The joint offset calculation portion 46 stores information indicating the calculated first joint offset and the information indicating the calculated second joint offset in the storage unit 32.

The error evaluation portion 47 reads the first calibration information stored in the storage unit 32 one by one, and calculates the first TCP position according to the forward kinematics based on the information indicating a rotation angle included in the first calibration information and the information indicating the first joint offset stored in the storage unit 32 for each piece of read first calibration information.

The error evaluation portion 47 calculates an amount indicating the degree of variation among the first TCP positions on the basis of the first TCP positions calculated for each piece of the first calibration information (that is, for each attitude of the robot 20). Hereinafter, as an example, a description will be made of a case where the amount indicating the variation degree is a standard deviation. In other words, the error evaluation portion 47 calculates a standard deviation of the first TCP positions as a first standard deviation on the basis of all the first TCP positions calculated for each piece of the first calibration information. The amount indicating the variation degree may be, for example, a variance or a standard error instead of the standard deviation. The error evaluation portion 47 determines (evaluates) whether or not the calculated first standard deviation is less than a predetermined value.

The error evaluation portion 47 reads the second calibration information stored in the storage unit 32 one by one, and calculates the second TCP position according to the forward kinematics based on the information indicating a rotation angle included in the second calibration information and the information indicating the second joint offset stored in the storage unit 32 for each piece of read second calibration information. The error evaluation portion 47 calculates a standard deviation of the second TCP positions as a second standard deviation on the basis of all the second TCP positions calculated for each piece of the second calibration information (that is, for each attitude of the robot 20). The error evaluation portion 47 determines (evaluates) whether or not the calculated second standard deviation is less than a predetermined value.

Hereinafter, with reference to FIG. 11, a description will be made of processes until the control apparatus 30 completes calibration of the first manipulator MNP1 and the second manipulator MNP2. Processes insteps S100 to S160 are the same as those in the second embodiment, and thus description thereof will be omitted.

The deviation in a position of the tip sphere TCP1 in the direction along the upper surface of the jig J1 while the tip sphere TCP1 is being separated from the depression H1 of the jig J1 in step S140 may be caused by an error generated when a position of the tip sphere TCP1 is moved due to a joint offset for correcting a rotation angle of each actuator being not calculated in this step, or fluctuation (change) in a value of the force sensor 23, in addition to vibration of the tip sphere TCP1.

In a case where the predetermined direction in step S140 is a vertically upward direction, an opposite direction to the predetermined direction indicates a vertically downward direction. The robot control portion 42 performs processes in steps S160 to S206 while maintaining a state in which a predetermined magnitude of force is applied to the tip sphere TCP1 fitted to the depression H1 in an opposite direction to the predetermined direction in step S140.

When the information indicating a rotation angle from an encoder related to each of the plurality of actuators of the first manipulator MNP1 is acquired in step S160, the robot control portion 42 measures the number of vibration per unit time of the first manipulator MNP1 by using the first force sensor 23-1, and waits for the measured number of vibration to be a threshold value or less. Consequently, the robot control portion 42 can prevent a rotation angle of each actuator from being changed due to the vibration of the first manipulator MNP1.

Next, the rotation angle acquisition portion 45 stores the information indicating the rotation angle acquired in step S160 in the storage unit 32 as the first calibration information (step S170). Next, the calibration control section 41 determines whether or not the number of pieces of first calibration information stored in the storage unit 32 is equal to or larger than a predefined number (step S180).

Here, the predefined number may be equal to or larger than the number of unknowns used to calculate the first joint offset in the joint offset calculation portion 46, and is assumed to be 10 in this example. The first calibration information is preferably acquired so that the plurality of actuators of the first manipulator MNP1 are moved at predetermined angles or more due to a changed attitude in step S190.

If the calibration control section 41 determines that the number of pieces of first calibration information stored in the storage unit 32 is not equal to or larger than the predefined number (NO in step S180), the robot control portion 42 controls the robot 20 to change an attitude of the first manipulator MNP1 to the next attitude (step S190), and then performs processes in steps S160 to S180 in the changed attitude of the first manipulator MNP1.

Here, when changing an attitude of the first manipulator MNP1 to the next attitude, the robot control portion 42 may read the information indicating the attitude stored in the storage unit 32 in order and may change the attitude of the first manipulator MNP1 in the reading order, and may change the attitude of the first manipulator MNP1 at random. An attitude of the first manipulator MNP1 is an example of an attitude of the first arm. An attitude of the second manipulator MNP2 is an example of an attitude of the second arm. When changing the attitude of the first manipulator MNP1, the robot control portion 42 changes the attitude according to control based on force sensor information. Consequently, the robot control portion 42 can change an attitude of the first manipulator MNP1 without destroying each member constituting the first end effector END1, the jig J1, or the first manipulator MNP1. When changing the attitude of the second manipulator MNP2, the robot control portion 42 changes the attitude according to compliance control. Consequently, the robot control portion 42 can change an attitude of the second manipulator MNP2 without destroying each member constituting the second end effector END2, the jig J1, or the second manipulator MNP2.

On the other hand, the calibration control section 41 determines that the number of pieces of first calibration information stored in the storage unit 32 is equal to or larger than the predefined number (YES in step S180), the robot control portion 42 changes the attitude of the first manipulator MNP1 to the attitude of the first manipulator MNP1 at the time when the tip sphere TCP1 is fitted to the depression H1 of the jig J1 in step S150 (step S202).

Here, with reference to FIGS. 9A to 9C, a description will be made of a process in which the robot control portion 42 changes an attitude of the first manipulator MNP1 in step S190.

While maintaining a state in which the tip sphere TCP1 is fitted to the depression H1 of the jig J1, the robot control portion 42 changes an attitude of the first manipulator MNP1 from the attitude of the first manipulator MNP1 illustrated in FIG. 9A to the attitude of the first manipulator MNP1 illustrated in FIG. 9B or 9C. Since the attitude is changed in the above-described way, it is possible to acquire a plurality of rotation angles which are different from each other for each attitude of the first manipulator MNP1 and each rotation angle of the plurality of actuators of the first manipulator MNP1 without changing the first TCP position which is set to the center of the tip sphere TCP1 from the fixed position X.

On the other hand, if the robot control portion 42 determines that the waist pivot of the robot 20 has been changed the predetermined number of times or more (YES in step S204), the robot control portion 42 returns to step S110 and performs the processes in steps S120 to S206 on the second manipulator MNP2 again (step S215). The processes in steps S160 to S206 are examples of processes in which the first calibration information acquisition operation is performed by the first manipulator MNP1 and the second calibration information acquisition operation is performed by the second manipulator MNP2.

After the processes in steps S160 to S206 on the second manipulator MNP2 are completed, the joint offset calculation portion 46 reads all of the pieces of calibration information (that is, the first calibration information and the second calibration information) stored in the storage unit 32. The joint offset calculation portion 46 calculates the first joint offset and the second joint offset on the basis of all of the read calibration information, and stores information indicating the calculated first joint offset and information indicating the calculated second joint offset in the storage unit 32 (step S220).

Storing of the information indicating the first joint offset and the information indicating the second joint offset in the storage unit 32 in step S220 is temporary storing for using the first joint offset and the second joint offset in a process in step S230 and is different from the above-described teaching of the first joint offset and the second joint offset.

Here, a description will be made of a process of calculating the first joint offset and the second joint offset in the joint offset calculation portion 46. In the forward kinematics, an equation for calculating the first TCP position is obtained for each piece of first calibration information (that is, for each combination of an attitude of the waist pivot of the robot 20 and an attitude of the first manipulator MNP1).

Input parameters of the equation for calculating the first TCP position are a rotation angle of the actuator of the waist pivot and rotation angles of the plurality of actuators of the first manipulator MNP1. The unknowns of the equation for calculating the first TCP position are the first joint offset (seven joint offsets) and coordinates (three coordinate values) indicating the first TCP position. The joint offset calculation portion 46 is not required to calculate all the unknowns from the equation for calculating the first TCP position. For example, in a case of outputting mechanical accuracy regarding the first TCP position, it is not necessary to calculate the first TCP position.

In the forward kinematics, an equation for calculating the second TCP position is obtained for each piece of second calibration information (that is, for each combination of an attitude of the waist pivot of the robot 20 and an attitude of the second manipulator MNP2). Input parameters of the equation for calculating the second TCP position are a rotation angle of the actuator of the waist pivot and rotation angles of the plurality of actuators of the second manipulator MNP2. The unknowns of the equation for calculating the second TCP position are the second joint offset (seven joint offsets) and coordinates (three coordinate values) indicating the second TCP position. The joint offset calculation portion 46 is not required to calculate all the unknowns from the equation for calculating the second TCP position. For example, in a case of outputting mechanical accuracy regarding the second TCP position, it is not necessary to calculate the second TCP position.

Here, in the robot system 2, the coordinates indicating the first TCP position included in each equation for calculating the first TCP position and the coordinates indicating the second TCP position included in each equation for calculating the second TCP position are necessarily common values since the first TCP position and the second TCP position are fixed to the fixed position X during the first calibration information acquisition operation and the second calibration information acquisition operation (the above-described constraint condition).

By using this constraint condition, the joint offset calculation portion 46 collectively solves simultaneous equations formed of a plurality of equations for calculating the first TCP position and a plurality of equations for calculating the second TCP position according to nonlinear optimization computation such as a steepest descent method, a Newton method, or a Levenberg-Marquardt method. More specifically, the joint offset calculation portion 46 derives a plurality of equations for calculating the first TCP position and a plurality of equations for calculating the second TCP position on the basis of the first calibration information and the second calibration information read from the storage unit 32, and collectively solves simultaneous equations formed of all of the derived equations according to nonlinear optimization computation such as a steepest descent method, a Newton method, or a Levenberg-Marquardt method.

As a result, the joint offset calculation portion 46 can calculate both of the first joint offset and the second joint offset, and coordinates indicating a position of the TCP in the shared robot coordinate system. The position of the TCP in the shared robot coordinate system indicates both of the first TCP position and the second TCP position fixed to the fixed position X. Consequently, the robot calibration system 2 can cause the first manipulator MNP1 and the second manipulator MNP2 to perform highly accurate cooperative work on the basis of the position represented in the shared robot coordinate system.

In the method of calculating the first joint offset and the second joint offset by solving the simultaneous equations formed of a plurality of equations which are derived on the basis of the first calibration information obtained by fixing the first TCP position to the fixed position X and the second calibration information obtained by fixing the second TCP position to the fixed position X, a joint offset for correcting a rotation angle of an actuator at the base (an end on an opposite side to the side on which the end effector is provided) of the manipulator is attempted to be calculated but is undefined in terms of mathematics related to the forward kinematics.

However, in the robot system 2, an actuator corresponding to the actuator of the base of the manipulator is the actuator of the waist pivot of the robot 20. For this reason, the robot system 2 can calculate both of the first joint offset and the second joint offset.

The robot system 2 calibrates the first manipulator MNP1 and the second manipulator MNP2 by using the calculated first joint offset and second joint offset and also fixing the waist pivot to a certain position, and can thus improve accuracy of cooperative work of the first manipulator MNP1 and the second manipulator MNP2. The robot system 2 may be configured to calibrate the actuator of the waist pivot by using other devices which calculate a joint offset of the actuator of the waist pivot.

Next, the error evaluation portion 47 reads the information indicating the first joint offset stored in the storage unit 32 in step S220, from the storage unit 32. The error evaluation portion 47 reads all of the pieces of first calibration information stored in step S170 from the storage unit 32 one by one. The error evaluation portion 47 calculates the first TCP position according to the forward kinematics based on the rotation angles included in the first calibration information and the read first joint offset for each piece of read first calibration information. The error evaluation portion 47 calculates a standard deviation of the first TCP positions on the basis of all the first TCP positions calculated for each piece of the first calibration information (that is, for each attitude of the robot 20).

In addition, the error evaluation portion 47 reads the information indicating the second joint offset stored in the storage unit 32 in step S220, from the storage unit 32. The error evaluation portion 47 reads all of the pieces of second calibration information stored in step S170 from the storage unit 32 one by one. The error evaluation portion 47 calculates the second TCP position according to the forward kinematics based on the rotation angles included in the second calibration information and the read second joint offset for each piece of read second calibration information. The error evaluation portion 47 calculates a standard deviation of the second TCP positions on the basis of all the second TCP positions calculated for each piece of the second calibration information (that is, for each attitude of the robot 20) (step S230).

Next, the error evaluation portion 47 determines (evaluates) whether or not both of the first standard deviation of the first TCP positions calculated in step S230 and the second standard deviation of the second TCP positions calculated in step S230 are less than a predetermined value Y1 (step S240). If it is determined that one of the first standard deviation of the first TCP positions calculated in step S230 and the second standard deviation of the second TCP positions calculated in step S230 is not less than the predetermined value Y1 (NO in step S240), the robot control portion 42 returns to step S110 and acquires the first calibration information and the second calibration information again so as to calculate the first joint offset and the second joint offset again.

On the other hand, if the error evaluation portion 47 determines that both of the first standard deviation of the first TCP positions calculated in step S230 and the second standard deviation of the second TCP positions calculated in step S230 are less than the predetermined value Y1 (YES in step S240), the teaching portion 48 stores information indicating the first joint offset and information indicating the second joint offset calculated in step S220 in the storage unit 32 (step S250). Storing of the information indicating the first joint offset and the information indicating the second joint offset in the storage unit 32 in step S250 indicates the above-described teaching of the first joint offset and the second joint offset.

In the present embodiment, the teaching portion 48 is configured to determine whether or not both of the first standard deviation of the first TCP positions calculated in step S230 and the second standard deviation of the second TCP positions calculated in step S230 are less than the predetermined value Y1, but, alternatively, if the error evaluation portion 47 determines that one of the first standard deviation of the first TCP positions calculated in step S230 and the second standard deviation of the second TCP positions calculated in step S230 is less than the predetermined value Y1, the information indicating the first joint offset and the information indicating the second joint offset calculated in step S220 may be stored (taught) in (to) the storage unit 32.

The first end effector END1 is an example of a first member of the first arm, and the second end effector END2 is an example of a first member of the second arm. The tip sphere TCP1 of the first end effector END1 is an example of a part of the first member of the first arm, and the tip sphere TCP2 of the second end effector END2 is an example of a part of the first member of the second arm.

The robot control portion 42 acquires the information indicating a rotation angle of each actuator by changing an attitude of the first manipulator MNP1 while maintaining a state in which the tip sphere TCP1 is fitted to the depression H1 of the jig J1, that is, comes into contact with the depression H1 of the jig J1 in the processes in steps S150 to S206, but, alternatively, may acquire the information indicating a rotation angle of each actuator by changing an attitude of the first manipulator MNP1 while maintaining a state in which the depression H1 and the tip sphere TCP1 are separated from each other by a predetermined distance. In this case, the robot control portion 42 changes an attitude of the first manipulator MNP1 so that a relative positional relationship between the tip sphere TCP1 and the depression H1 is not changed (that is, the relative positional relationship is fixed). A distance between the tip sphere TCP1 and the depression H1 when a relative positional relationship between the tip sphere TCP1 and the depression H1 is fixed is a distance between, for example, the deepest portion (the center of the depression H1 in this example) of the depression H1 and a point where the tip sphere TCP1 is in contact with the depression H1, but may be a distance between other two points. A distance between the tip sphere TCP1 and the depression H1 when a relative positional relationship between the tip sphere TCP1 and the depression H1 is fixed is an example of a distance of 1.

The robot control portion 42 acquires the information indicating a rotation angle of each actuator by changing an attitude of the second manipulator MNP2 while maintaining a state in which the tip sphere TCP2 is fitted to the depression H1 of the jig J1, that is, comes into contact with the depression H1 of the jig J1 in the processes in steps S150 to S206, but, alternatively, may acquire the information indicating a rotation angle of each actuator by changing an attitude of the second manipulator MNP2 while maintaining a state in which the depression H1 and the tip sphere TCP2 are separated from each other by a predetermined distance. In this case, the robot control portion 42 changes an attitude of the second manipulator MNP2 so that a relative positional relationship between the tip sphere TCP2 and the depression H1 is not changed (that is, the relative positional relationship is fixed). A distance between the tip sphere TCP2 and the depression H1 when a relative positional relationship between the tip sphere TCP2 and the depression H1 is fixed is a distance between, for example, the deepest portion (the center of the depression H1 in this example) of the depression H1 and a point where the tip sphere TCP2 is in contact with the depression H1, but may be a distance between other two points. A distance between the tip sphere TCP2 and the depression H1 when a relative positional relationship between the tip sphere TCP2 and the depression H1 is fixed is an example of a distance of 2.

As described above, in the present embodiment, the robot calibration system 2 performs a first operation of moving the tip sphere TCP1 so that a distance between the tip sphere TCP1 and the jig J1 becomes the distance of 1, and then causing the first manipulator MNP1 to take a plurality of attitudes, and a second operation of moving the tip sphere TCP2 so that a distance between the tip sphere TCP2 and the jig J1 becomes the distance of 2, and then causing the second manipulator MNP2 to take a plurality of attitudes, and calibrates the first manipulator MNP1 and the second manipulator MNP2 on the basis of results of the first operation and the second operation. Consequently, the robot calibration system 2 can minimize errors in which work is performed by a plurality of manipulators (arms).

The robot calibration system 2 performs a first operation of moving the tip sphere TCP1 so that a distance between the tip sphere TCP1 and the jig J1 becomes the distance of 1, and then causing the first manipulator MNP1 to take a plurality of attitudes, and a second operation of moving the tip sphere TCP2 so that a distance between the tip sphere TCP2 and the jig J1 becomes the distance of 2 which is the substantially the same as the distance of 1, and then causing the second manipulator MNP2 to take a plurality of attitudes, and calibrates the first manipulator MNP1 and the second manipulator MNP2 on the basis of results of the first operation and the second operation. Consequently, the robot calibration system 2 can calibrate the first manipulator MNP1 and the second manipulator MNP2 by causing the first manipulator MNP1 to take one or more attitudes while maintaining a predetermined distance between the tip sphere TCP1 and the jig J1, and by causing the second manipulator MNP2 to take one or more attitudes while maintaining a predetermined distance between the tip sphere TCP2 and the jig J1.

The robot calibration system 2 performs a first operation of moving the tip sphere TCP1 so that a distance between the tip sphere TCP1 and the jig J1 becomes 0, and then causing the first manipulator MNP1 to take a plurality of attitudes, and a second operation of moving the tip sphere TCP2 so that a distance between the tip sphere TCP2 and the jig J1 becomes 0, and then causing the second manipulator MNP2 to take a plurality of attitudes, and calibrates the first manipulator MNP1 and the second manipulator MNP2 on the basis of results of the first operation and the second operation. Consequently, the robot calibration system 2 can calibrate the first manipulator MNP1 and the second manipulator MNP2 by causing the first manipulator MNP1 to take one or more attitudes while maintaining a state in which the tip sphere TCP1 is in contact with the jig J1, and by causing the second manipulator MNP2 to take one or more attitudes while maintaining a state in which the tip sphere TCP2 is in contact with the jig J1.

The robot calibration system 2 performs a first operation of moving the tip sphere TCP1 so that a distance between the tip sphere TCP1 and the jig J1 becomes the distance of 1, and then causing the first manipulator MNP1 to take a plurality of attitudes on the basis of at least force sensor information acquired from the first force sensor 23-1, and a second operation of moving the tip sphere TCP2 so that a distance between the tip sphere TCP2 and the jig J1 becomes the distance of 2, and then causing the second manipulator MNP2 to take a plurality of attitudes on the basis of at least force sensor information acquired from the second force sensor 23-2. Consequently, the robot calibration system 2 can calibrate the first manipulator MNP1 and the second manipulator MNP2 on the basis of the first operation and the second operation based on the force sensor information acquired from the force sensor 23.

In a case where the tip sphere TCP1 is moved so that a distance between the tip sphere TCP1 and the jig J1 becomes the distance of 1, the robot calibration system 2 moves the tip sphere TCP1 so that a distance between the tip sphere TCP1 and the jig J1 becomes the distance of 1, then initializes the first force sensor 23-1 by moving the tip sphere TCP1 so that a distance between the tip sphere TCP1 and the jig J1 becomes a distance which is different from the distance of 1, and then moves the tip sphere TCP1 so that a distance between the tip sphere TCP1 and the jig J1 becomes the distance of 1. In addition, in a case where the tip sphere TCP2 is moved so that a distance between the tip sphere TCP2 and the jig J1 becomes the distance of 2, the robot calibration system 2 moves the tip sphere TCP2 so that a distance between the tip sphere TCP2 and the jig J1 becomes the distance of 2, then initializes the second force sensor 23-2 by moving the tip sphere TCP2 so that a distance between the tip sphere TCP2 and the jig J1 becomes a distance which is different from the distance of 2, and then moves the tip sphere TCP2 so that a distance between the tip sphere TCP2 and the jig J1 becomes the distance of 2. Consequently, the robot calibration system 2 can minimize errors caused by an external force such as gravity applied to the first force sensor 23-1 and the second force sensor 23-2.

When the first force sensor 23-1 is initialized, the robot calibration system 2 waits for vibration of the first end effector END1 to be reduced, then initializes the first force sensor 23-1, and moves the tip sphere TCP1 so that a distance between the tip sphere TCP1 and the jig J1 becomes the distance of 1. When the second force sensor 23-2 is initialized, the robot calibration system 2 waits for vibration of the second end effector END2 to be reduced, then initializes the second force sensor 23-2, and moves the tip sphere TCP2 so that a distance between the tip sphere TCP2 and the jig J1 becomes the distance of 2. Consequently, the robot system 2 can minimize errors in the initialization of the first force sensor 23-1, caused by vibration of the first end effector END1, and errors in the initialization of the second force sensor 23-2, caused by vibration of the second end effector END2.

The robot calibration system 2 performs the first calibration information acquisition operation in which the first manipulator MNP1 takes a plurality of attitudes in a state in which the tip sphere TCP1 which is a predetermined portion of the first end effector END1 having the offset structure is moved so that a distance between the tip sphere TCP1 and the jig J1 becomes the distance of 1, and the second calibration information acquisition operation in which the second manipulator MNP2 takes a plurality of attitudes in a state in which the tip sphere TCP2 which is a predetermined portion of the second end effector END2 having the offset structure is moved so that a distance between the tip sphere TCP2 and the jig J1 becomes the distance of 2. Consequently, the robot calibration system 2 can calibrate a rotation axis of the tip of the first manipulator MNP1 and a rotation axis of the tip of the second manipulator MNP2 on the basis of results of the first calibration information acquisition operation and the second calibration information acquisition operation.

The robot calibration system 2 performs the first calibration information acquisition operation in which the first manipulator MNP1 takes a plurality of attitudes in a state in which the tip sphere TCP1 is moved is in contact with the depression H1 of the jig J1, and the second calibration information acquisition operation in which the second manipulator MNP2 takes a plurality of attitudes in a state in which the tip sphere TCP2 is in contact with the depression H1 of the jig J1. Consequently, the robot calibration system 2 can fix a position of the TCP1 and a position of the TCP2 to the same position, and, as a result, can minimize errors caused by a position of the contact point between either or both of the tip sphere TCP1 and the tip sphere TCP2 and the jig J1 being deviated.

The robot calibration system 2 collectively calibrates parameters for controlling the first manipulator MNP1 and parameters for controlling the second manipulator MNP2 on the basis of results of the first calibration information acquisition operation and the second calibration information acquisition operation. Consequently, the robot calibration system 2 can minimize errors related to the calibration of the parameters for controlling the first manipulator MNP1 and the combination of the parameters for controlling the second manipulator MNP2.

### Fifth Embodiment

Hereinafter, a fifth embodiment will be described with reference to the drawings.

A robot calibration system (robot system) 3 according to the fifth embodiment includes a robot 20a and a control apparatus 30a as illustrated in FIG. 12. In the fifth embodiment, the same constituent elements as in the fourth embodiment are given the same reference numerals, and description thereof will be omitted.

The robot 20a illustrated in FIG. 12 is in a state in which calibration of each of the first manipulator MNP1 and the second manipulator MNP2 has been performed on the robot 20 of the fourth embodiment according to the method described in the fourth embodiment. Instead of the first end effector END1 and the second end effector END2 provided in the robot 20, the robot 20a is provided with a third end effector END3 and a fourth end effector END4 each including a claw portion which can grip the work target M. Hereinafter, a description will be made assuming that the robot 20a calibrates the first manipulator MNP1 and the second manipulator MNP2 and replaces the first end effector END1 and the second end effector END2 with the third end effector END3 and the fourth end effector END4.

The robot calibration system 3 causes the third end effector END3 to grip one end of the work target M disposed on the upper surface of the work table TB and to move the work target M to a predefined position. Thereafter, the robot calibration system 3 causes the fourth end effector END4 to grip the other end of the work target M which is not gripped by the third end effector END3. The robot calibration system 3 separates the third end effector END3 from the work target M. In other words, the robot calibration system 3 causes the work target M gripped by the third end effector END3 to be shifted to the fourth end effector END4. The robot calibration system. 3 causes the robot 20a to perform cooperative work such as shifting of the work target M.

Hereinafter, such cooperative work will be referred to as predetermined work. In the present embodiment, the first arm is constituted of the first manipulator MNP1 and the third end effector END3, and the second arm is constituted of the second manipulator MNP2 and the fourth end effector END4. When the predetermined work is performed, the robot calibration system 3 fixes a rotation angle of the waist pivot of the robot 20a to a certain rotation angle, and causes the robot 20a to perform the predetermined work by using both of the first arm and the second arm.

The work target M is an object having a size and a shape which can be gripped by both of the third end effector END3 and the fourth end effector END4, and is, for example, a part (a screw or a bolt) used in an industrial machine. In FIG. 12, the work target M is illustrated as a rectangular parallelepiped object, but may be objects having other shapes or sizes.

The first fixed imaging unit 21 and the second fixed imaging unit 22 capture images of an imaging region is a stereoscopic manner. Hereinafter, images captured by the first fixed imaging unit 21 and the second fixed imaging unit in a stereoscopic manner will be referred to as stereoscopically captured images. Here, the imaging region indicates a region which can be captured in a stereoscopic manner by the first fixed imaging unit 21 and the second fixed imaging unit 22 when a rotation angle of the waist pivot is fixed to a certain rotation angle. The work target M and the predetermined position where the work target M is disposed are assumed to be included in the region which can be imaged by the first fixed imaging unit 21 and the second fixed imaging unit 22 in a stereoscopic manner. The stereoscopic captured image is a still image, but, alternatively, may be a moving image.

A position on the stereoscopic captured image and a position in a camera coordinate system are assumed to be correlated with each other in advance through any calibration. A position in a shared robot coordinate system and a position in the camera coordinate system are assumed to be correlated with each other in advance through any calibration.

Each of the functional units (the first moving imaging unit 11, the second moving imaging unit 12, the first fixed imaging unit 21, the second fixed imaging unit 22, the first force sensor 23-1, the second force sensor 23-2, the third end effector END3, the fourth end effector END4, the first manipulator MNP1, the second manipulator MNP2, and a plurality of actuators (not illustrated)) provided in the robot 20a is controlled on the basis of a control signal which is input from the control apparatus 30a. The robot 20a performs the predetermined work on the basis of a control signal which is input from the control apparatus 30a.

The control apparatus 30a calibrates each of the first manipulator MNP1 and the second manipulator MNP2 according to the method described in the fourth embodiment. After the first end effector END1 and the second end effector END2 of the robot 20a are replaced with the third end effector END3 and the fourth end effector END4 by a user, the control apparatus 30a causes the first fixed imaging unit 21 and the second fixed imaging unit 22 to stereoscopically image the range which can be imaged by the first fixed imaging unit 21 and the second fixed imaging unit 22, and detects the work target M through pattern matching or the like on the basis of stereoscopically captured images which have been captured. In a case where the work target M is detected from the stereoscopically captured images, the control apparatus 30a calculates a position and an attitude of the work target M in the camera coordinate system on the basis of the stereoscopically captured images.

The control apparatus 30a transforms the position and the attitude of the work target M in the camera coordinate system into a position and an attitude in the shared robot coordinate system. The control apparatus 30a causes the third end effector END3 to grip the work target M and causes the fourth end effector END4 to grip the gripped work target M again on the basis of the position and the attitude of the work target M in the shared robot coordinate system obtained through the transform, and to dispose the gripped work target M at a predetermined position.

As described above, the robot calibration system 3 according to the fifth embodiment can perform the predetermined work with high accuracy through the calibration of the plurality of manipulators described in the fourth embodiment.

The embodiments of the invention have been described in detail with reference to the drawings, but specific configurations are not limited to the embodiments and may be changed, replaced, or removed without departing from the spirit of the invention.

A program for realizing a function of any configuration unit of the above-described apparatus (for example, the control apparatus 30 of the robot system 1, the control apparatus 30 of the robot system 2, and the control apparatus 30a of the robot system 3) may be recorded on a computer readable recording medium, and a computer system may read the program so as to execute the program. The “computer system” mentioned here includes an operation system (OS) or hardware such as peripheral devices. The “computer readable recording medium” indicates a portable medium such as a flexible disc, a magneto-optical disc, a ROM, or a compact disk (CD)-ROM, and a storage device such as a hard disk built into the computer system. The “computer readable recording medium” also includes a memory which holds the program for a predetermined period of time, such as a volatile memory (RAM) which serves as a sever or a client when the program is transmitted via a network such as the Internet or a communication line such as a communication line.

The program may be transmitted from a computer system in which the program is stored in a storage device or the like to another computer system via a transmission media or by using a carrier wave in the transmission medium. Here, the “transmission medium” for transmitting the program includes a medium having a function of transmitting information, such as a network (communication network) such as the Internet or a communication line such as a telephone line.

The program may realize some of the above-described functions. The program may be a so-called differential file (differential program) which can realize the above-described functions in combination with a program which has already been recorded in the computer system.

The entire disclosure of Japanese Patent Application No. 2014-261868, filed Dec. 25, 2014; No. 2014-259934, filed Dec. 24, 2014 and No. 2014-261869, filed Dec. 25, 2014 are expressly incorporated by reference herein.

What is claimed is:

1. A robot comprising:
an arm; and
a force sensor,
wherein the arm is calibrated by causing the arm to take a plurality of attitudes on the basis of an output value from at least the force sensor in a state in which a part of a first member attached to a tip of the arm is moved so that a distance between the part and a second member becomes a distance of 1 for each of a plurality of second members, the part being provided at a position which is not present on a rotation axis of the tip of the arm.

2. The robot according to claim 1,
wherein the distance of 1 is substantially 0.

3. The robot according to claim 1,
wherein, for each of the plurality of second members, the robot moves the part of the first member so that a distance between the part and the second member becomes the distance of 1, then moves the part so that a distance between the part and the second member becomes a distance which is different from the distance of 1 so as to initialize the force sensor, and then moves the part of the first member so that a distance between the part and the second member becomes the distance of 1.

4. The robot according to claim 3,
wherein, when the force sensor is initialized, the robot initializes the force sensor after waiting for vibration of the first member to be reduced, and moves the part of the first member so that a distance between the part and the second member becomes the distance of 1.

5. The robot according to claim 1,
wherein the robot causes the arm to take a plurality of attitudes in a state in which the part of the first member is in contact with a depression of the second member.

6. The robot according to claim 1, further comprising:
two or more arms,
wherein the robot collectively calibrates the two or more arms.

7. A robot system comprising:
a robot including an arm and a force sensor;
a control apparatus that operates the robot;
a first member that includes an end portion at a position which is not present on a rotation axis of a tip of the arm; and
a plurality of second members,
wherein the control apparatus calibrates the arm by causing the arm to take a plurality of attitudes on the basis of an output value from at least the force sensor in a state in which a part of the first member attached to the tip of the arm is moved so that a distance between the part and the second member becomes a distance of 1 for each of the plurality of second members, the part being provided at a position which is not present on the rotation axis of the tip of the arm.

8. A control apparatus that calibrates an arm of a robot by causing the arm to take a plurality of attitudes on the basis of an output value from at least a force sensor in a state in which a part of a first member attached to a tip of the arm is moved so that a distance between the part and a second member becomes a distance of 1 for each of a plurality of second members, the part being provided at a position which is not present on a rotation axis of the tip of the arm.

9. A control method comprising:
calibrating an arm of a robot by causing the arm to take a plurality of attitudes on the basis of an output value from at least a force sensor in a state in which a part of a first member attached to a tip of the arm is moved so that a distance between the part and a second member becomes a distance of 1 for each of a plurality of second members, the part being provided at a position which is not present on a rotation axis of the tip of the arm.
